(19) United States
(12) Patent Application Publication
(10) Pub. No.: US 2015/0074159 A1
(43) Pub. Date: Mar. 12, 2015

(54) METHODS FOR DETERMINING A RESULT OF APPLYING A FUNCTION TO AN INPUT AND EVALUATION DEVICES

(71) Applicants: Axel York POSCHMANN, Singapore (SG); Sebastian Thomas KUTZNER, Singapore (SG); Ha NGUYEN PHUONG, Singapore (SG)

(72) Inventors: Axel York POSCHMANN, Singapore (SG); Sebastian Thomas KUTZNER, Singapore (SG); Ha NGUYEN PHUONG, Singapore (SG)

(21) Appl. No.: 14/542,473

(22) Filed: Nov. 14, 2014

Related U.S. Application Data
(63) Continuation of application No. PCT/SG2013/000199, filed on May 16, 2013.
(60) Provisional application No. 61/647,809, filed on May 16, 2012.

(51) Int. Cl. G06F 7/544

(52) U.S. Cl. CPC G06F 7/544
USPC 708/270

(57) ABSTRACT

According to various embodiments, a method for determining a result of applying a first function to an input may be provided. The method may include: determining a second function; and applying the second function to a value based on the input to determine a first intermediate value; applying the second function to a value based on the intermediate value to determine the result.

### CROSS-REFERENCE TO RELATED APPLICATIONS

The present application is a continuation of International Application No. PCT/SG2013/000199 filed on 16 May 2013, which claims the benefit of the U.S. provisional patent application No. 61/647,809 filed on 16 May 2012, the entire contents of which are incorporated herein by reference for all purposes.

### TECHNICAL FIELD

Embodiments relate generally to methods for determining a result of applying a function to an input and evaluation devices.

### BACKGROUND

Cryptographic devices may be widely deployed, and may be embedded in everyday items. The attacker may have full control, and the secrecy of a key may be crucial. The attacker's goal may be to reveal the key. Thus, it may be desirable to provide devices and methods to enhance protection.

### SUMMARY

According to various embodiments, a method for determining a result of applying a first function to an input may be provided. The method may include: determining a second function; and applying the second function to a value based on the input to determine a first intermediate value; applying the second function to a value based on the intermediate value to determine the result.

According to various embodiments, an evaluation device may be provided. The evaluation device may include: a determination circuit configured to determine a second function; an application circuit configured to apply the second function to a value based on an input to determine a first intermediate value; wherein the application circuit is further configured to apply the second function to a value based on the intermediate value to determine a result of applying a first function to the input.

According to various embodiments, a method for determining a result of applying a first function to an input may be provided. The method may include: determining a plurality of further functions; applying a first further function of the plurality of further functions to the input to determine a first intermediate value; applying a second further function of the plurality of further functions to the first intermediate value to determine a second intermediate value; applying a third further function of the plurality of further functions to the input to determine a third intermediate value; applying a fourth further function of the plurality of further functions to the third intermediate value to determine a fourth intermediate value; determining the result based on the second intermediate value and the fourth intermediate value.

According to various embodiments, an evaluation device may be provided. The evaluation device may include: a determination circuit configured to determine a plurality of further functions; an application circuit configured to apply a first further function of the plurality of further functions to an input to determine a first intermediate value; wherein the application circuit is further configured to apply a second further function of the plurality of further functions to the first intermediate value to determine a second intermediate value; wherein the application circuit is further configured to apply a third further function of the plurality of further functions to the input to determine a third intermediate value; wherein the application circuit is further configured to apply a fourth further function of the plurality of further functions to the third intermediate value to determine a fourth intermediate value; and wherein the application circuit is further configured to determine a result of applying a first function to the input based on the second intermediate value and the fourth intermediate value.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1A shows a flow diagram illustrating a method for determining a result of applying a first function to an input according to various embodiments;

FIG. 1B shows an evaluation device according to various embodiments;

FIG. 1C shows a flow diagram illustrating a method for determining a result of applying a first function to an input according to various embodiments;

FIG. 2 shows an illustration for one example for a 4×4 S-box;

FIG. 3 shows a flowchart illustrating a method for generating a hardware friendly decomposition according to various embodiments;

FIG. 4 shows a flowchart illustrating how to use the Fᵢ and G in a hardware efficient way according to various embodiments;

FIG. 5 shows a flow diagram according to various embodiments;

FIG. 6 shows an architecture according to various embodiments;

FIG. 7 shows one round of the block cipher PRESENT;

FIG. 8A shows a commonly used architecture;

FIG. 8B shows an illustration showing how the architecture of FIG. 8A can be modified using the methods described;

FIG. 9 shows an illustration of the experimental setup according to various embodiments;

FIG. 10A and FIG. 10B show diagrams of an exemplary power trace according to various embodiments;

FIG. 11 shows correlation results using a commonly used model and a model according to various embodiments;

FIG. 12 shows the results of the DPA attack for the four models;

FIG. 13 shows results using the sum of square t-differences;

FIG. 14 shows DPA results of the Zero-o set attack; and

FIG. 15A and FIG. 15B show power traces.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

In this context, the evaluation device as described in this description may include a memory which is for example used in the processing carried out in the evaluation device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

Cryptographic devices may be widely deployed, and may be embedded in everyday items. The attacker may have full control, and the secrecy of a key may be crucial. The attacker's goal may be to reveal the key. Thus, it may be desirable to provide devices and methods to enhance protection.

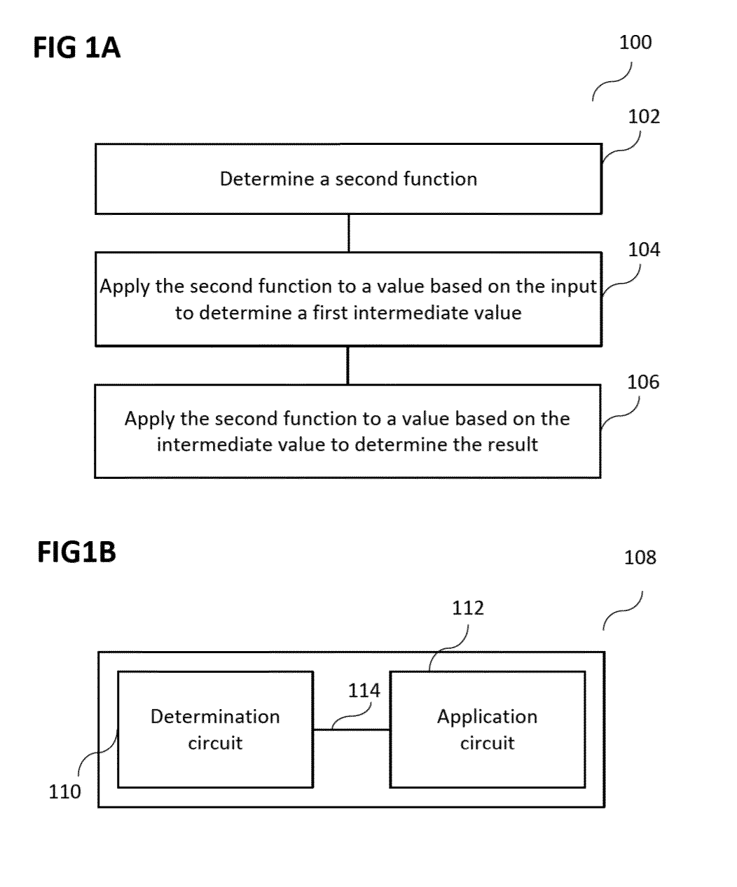

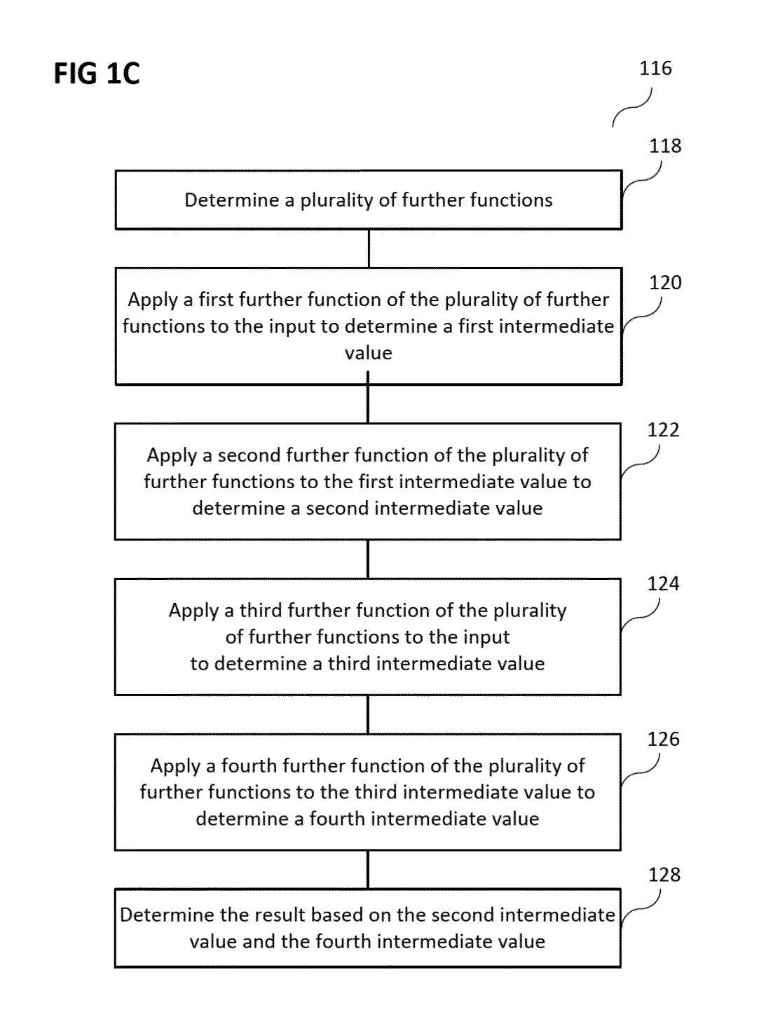

FIG. 1A shows a flow diagram 100 illustrating a method (for example according to a decomposition method according to various embodiments as described further below) for determining a result of applying a first function to an input according to various embodiments. In 102, a second function may be determined. In 104, the second function may be applied to a value based on the input to determine a first intermediate value. In 106, the second function may be applied to a value based on the intermediate value to determine the result.

According to various embodiments, the first function may include or may be a first Boolean function and/or a first vectorial Boolean function. According to various embodiments, the second function may include or may be a second Boolean function and/or a second vectorial Boolean function.

According to various embodiments, the method may further include: determining a linear function; applying a linear function to the input to determine a second intermediate value; and applying the second function to the second intermediate value to determine the first intermediate value.

According to various embodiments, the method may further include iteratively applying the second function to determine the result.

According to various embodiments, the method may further include: determining a plurality of linear functions; iteratively performing to determine the result; and applying one of the linear functions and then applying the second function.

According to various embodiments, the first function may be a first vectorial Boolean function of a pre-determined first degree, and the second function may be a second vectorial Boolean function of a pre-determined second degree. The second degree may be lower than the first degree.

FIG. 1B shows an evaluation device 108 according to various embodiments. The evaluation device 108 may include a determination circuit 110 configured to determine a second function. The evaluation device 108 may further include an application circuit 112 configured to apply the second function to a value based on an input to determine a first intermediate value. The determination circuit 110 and the application circuit 112 may be coupled with each other, for example via a connection 114, for example an optical connection or an electrical connection, such as for example a cable or a computer bus or via any other suitable electrical connection to exchange electrical signals. The application circuit 112 may further be configured to apply the second function to a value based on the intermediate value to determine a result of applying a first function to the input

According to various embodiments, the first function may include or may be a first Boolean function and/or a first vectorial Boolean function. According to various embodiments, the second function may include or may be a second Boolean function and/or a second vectorial Boolean function.

According to various embodiments, the determination circuit 110 may further be configured to determine a linear function. The application circuit 112 may further be configured to apply a linear function to the input to determine a second intermediate value. The application circuit 112 may further be configured to apply the second function to the second intermediate value to determine the first intermediate value.

According to various embodiments, the application circuit 112 may further be configured to iteratively apply the second function to determine the result.

According to various embodiments, the determination circuit 110 may further be configured to determine a plurality of linear functions. The application circuit 112 may further be configured to iteratively perform to determine the result. The application circuit 112 may further be configured to apply one of the linear functions and then applying the second function.

According to various embodiments, the first function may be a first vectorial Boolean function of a pre-determined first degree. The second function may be a second vectorial Boolean function of a pre-determined second degree. The second degree may be lower than the first degree.

FIG. 1C shows a flow diagram 116 illustrating a method (for example according to a construction method according to various embodiments as described further below) for determining a result of applying a first function to an input according to various embodiments. In 118, a plurality of further functions may be determined. In 120, a first further function of the plurality of further functions may be applied to the input to determine a first intermediate value. In 122, a second further function of the plurality of further functions may be applied to the first intermediate value to determine a second intermediate value. In 124, a third further function of the plurality of further functions may be applied to the input to determine a third intermediate value. In 126, a fourth further function of the plurality of further functions may be applied to the third intermediate value to determine a fourth intermediate value. In 128, the result may be determined based on the second intermediate value and the fourth intermediate value.

According to various embodiments, the first function may include or may be a first Boolean function and/or a first vectorial Boolean function. According to various embodiments, the plurality of further functions may include or may be a plurality of further Boolean functions and/or a plurality of further vectorial Boolean functions.

According to various embodiments, the result may be determined based on a bitwise XOR operation of the second intermediate value and the fourth intermediate value.

According to various embodiments, the method may further include: determining a plurality of intermediate values, wherein each intermediate value of the plurality of intermediate values is determined based on applying one of the plurality of second functions to the input, and then applying a further one of the plurality of second functions; and determining the result based on the plurality of intermediate values.

According to various embodiments, the result may be determined based on a bitwise XOR operation of the plurality of intermediate values.

According to various embodiments, the first function may be a first vectorial Boolean function of a pre-determined first degree. Each of the second function may be a (different) second vectorial Boolean function. A degree of each of the second functions may be lower than the first degree.

FIG. 1B shows an evaluation device 108 according to various embodiments. The evaluation device 108 may include a determination circuit 110 configured to determine a plurality of further functions. The evaluation device 108 may further include an application circuit 112 configured to apply a first further function of the plurality of further functions to an input to determine a first intermediate value. The determination circuit 110 and the application circuit 112 may be coupled with each other, for example via a connection 114, for example an optical connection or an electrical connection, such as for example a cable or a computer bus or via any other suitable electrical connection to exchange electrical signals. The application circuit 112 may further be configured to apply a second further function of the plurality of further functions to the first intermediate value to determine a second intermediate value. The application circuit 112 may further be configured to apply a third further function of the plurality of further functions to the input to determine a third intermediate value. The application circuit 112 may further be configured to apply a fourth further function of the plurality of further functions to the third intermediate value to determine a fourth intermediate value. The application circuit 112 may further be configured to determine a result of applying a first function to the input based on the second intermediate value and the fourth intermediate value.

According to various embodiments, the first function may include or may be a first Boolean function and/or a first vectorial Boolean function. According to various embodiments, the plurality of further functions may include or may be a plurality of further Boolean functions and/or a plurality of further vectorial Boolean functions.

According to various embodiments, the application circuit 112 may further be configured to determine the result is determined based on a bitwise XOR operation of the second intermediate value and the fourth intermediate value.

According to various embodiments, the application circuit 112 may further be configured to determine a plurality of intermediate values, wherein each intermediate value of the plurality of intermediate values is determined based on applying one of the plurality of second functions to the input, and then applying a further one of the plurality of second functions. The application circuit 112 may further be configured to determine the result based on the plurality of intermediate values.

According to various embodiments, the application circuit 112 may further be configured to determine the result based on a bitwise XOR operation of the plurality of intermediate values.

According to various embodiments, the first function may be a first vectorial Boolean function of a pre-determined first degree. Each of the second function may be a second vectorial Boolean function. A degree of each of the second functions may be lower than the first degree.

According to various embodiments, a novel way of constructing Functions using Functions of lower degree may be provided. Among many other fields, devices and methods according to various embodiments may have applications to cryptography, as one of its main building blocks, so-called S-boxes, may be represented as vectorial Boolean functions. It will however be understood that the application of the devices and methods is not limited to applications in cryptography only. An S-box (Substitution-Box) layer in a cipher or any symmetric key cryptography primitive may aim at providing confusion. More precisely, confusion may be the property of an operation to obscure the relationship between the key and the cipher text. This may represent one of the vital components of any symmetric key cryptography primitive (e.g. block ciphers, hash functions).

S-boxes S(x), for example n×m S-boxes, may have n-bit input and m-bit output, and common examples are 4×4 as used in PRESENT, 6×4 (DES), or 8×8 (AES). An S-box can be viewed as a vectorial Boolean function with certain properties. Desired goals are high non-linearity and a uniform differential distribution. Another important property of an S-box is its algebraic degree (also simply called “degree”), which should be as high as possible. However, the algebraic degree is dependent on n and it can be at most n−1.

A high algebraic degree also implies high implementation costs in hardware, since the complexity increases with an increasing algebraic degree. It is thus favorable to decompose an S-box S (in other words: to provide a decomposition of an S-box S) into a series of vectorial Boolean functions Pᵢ with reduced degree.

The minimal degree is 2, hence the optimal solution for any S-box is to include a series of vectorial Boolean functions of algebraic degree 2 (also called quadratic).

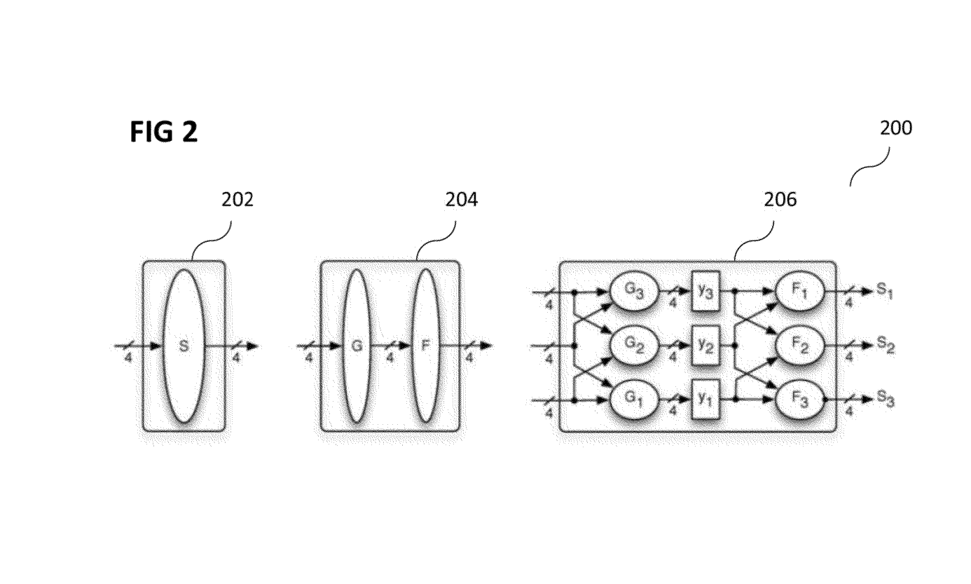

FIG. 2 shows an illustration 200 for one example for a 4×4 S-box 202 that is decomposed into two quadratic functions P₁ (G) and P₂ (F) 204, like will be described in more detail below. This may provide a side-channel resistance against 1st-order DPA (differential power analysis) attacks.

According to various embodiments, a method for decomposition may be provided. According to various embodiments, a method may be provided to replace a given vectorial boolean function S(x) with the formula Fₙ(G( . . . (F₂(G(F₁(G(F₀(x)))))) . . . )), or in a more comprehensive way of representation:

$$\begin{matrix}S ( x ) = {F}_{n} ( G ( {y}_{n} ) ) \\ {y}_{n} = {F}_{n - 1} ( G ( {y}_{n - 1} ) ) \\ … \\ {y}_{1} = {F}_{1} ( G ( {y}_{0} ) ) \\ {y}_{0} = {F}_{0} ( x ) ,\end{matrix}$$

with Fᵢ being linear functions and utilizing a vectorial boolean function G in a recursive way. The vectorial boolean function G may be of lower degree, hence, it may be efficiently implemented in hardware due to the lower complexity. According to various embodiments, it may be started by choosing an arbitrary G (most preferably one which is efficient to implement) and then try to find Fᵢ's such that the equation results in the intended vectorial boolean function S. The most efficient way is to choose a G such that all Fᵢ(x)=x.

According to various embodiments, a method for construction a vectorial boolean function with a set of lower degree vectorial boolean functions. According to various embodiments, devices and methods may be provided to construct a vectorial boolean function S(x) by using a set of chosen lower degree vectorial boolean functions A₁(x), B₁(x), A₂(x), B₂(x), . . . , Aₙ(x), Bₙ(x) which can be described as follows:

S(x)=A₁(B₁(x)) XOR A₂(B₂(x)) XOR . . . XOR Aₙ(Bₙ(x)) where XOR (or ⊕) may denote the bitwise XOR operation, i.e. the addition modulo 2.

This function may be used in a recursive way, for example, to further lower the degree of A₁(x), B₁(x), . . . , Aₙ(x), Bₙ(x) by using the same formula.

It may be understood that the method according to various embodiments allows to construct higher degree vectorial boolean functions which were previously thought to be not decomposable into lower degree vectorial boolean functions.

According to various embodiments, serially decomposable S-Boxes may be provided.

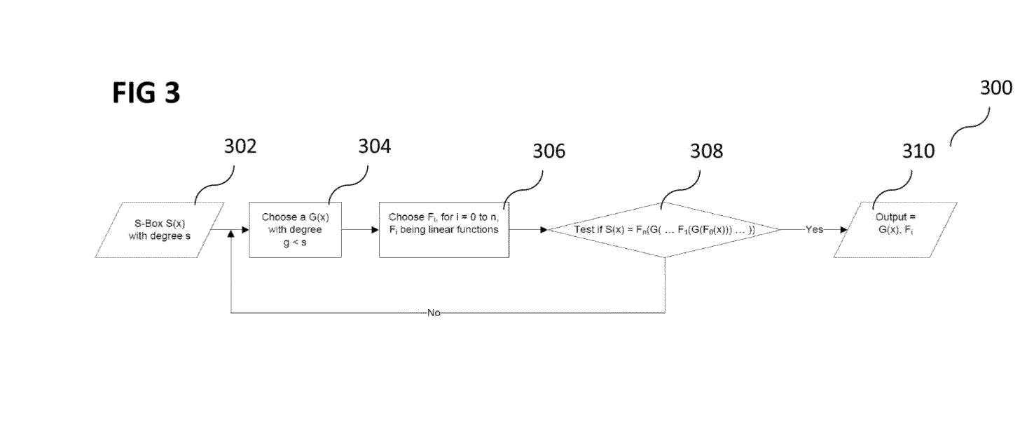

FIG. 3 shows a flowchart 300 illustrating a method for generating a hardware friendly decomposition according to various embodiments, consisting of linear functions Fi and a Boolean function G. In 302, an S-Box S(x) with degree s may be determined. In 304, a G(x) with degree g<s may be determined. In 306, for each integer number i between 0 and n, a linear function Fᵢ may be chosen. In 308, it may be tested in S(x)=Fₙ(G( . . . F₁(G(F₀(x))) . . . ))). If so, G(x) and Fᵢ may be output in 310. Otherwise, a different G(x) may be chosen in 304.

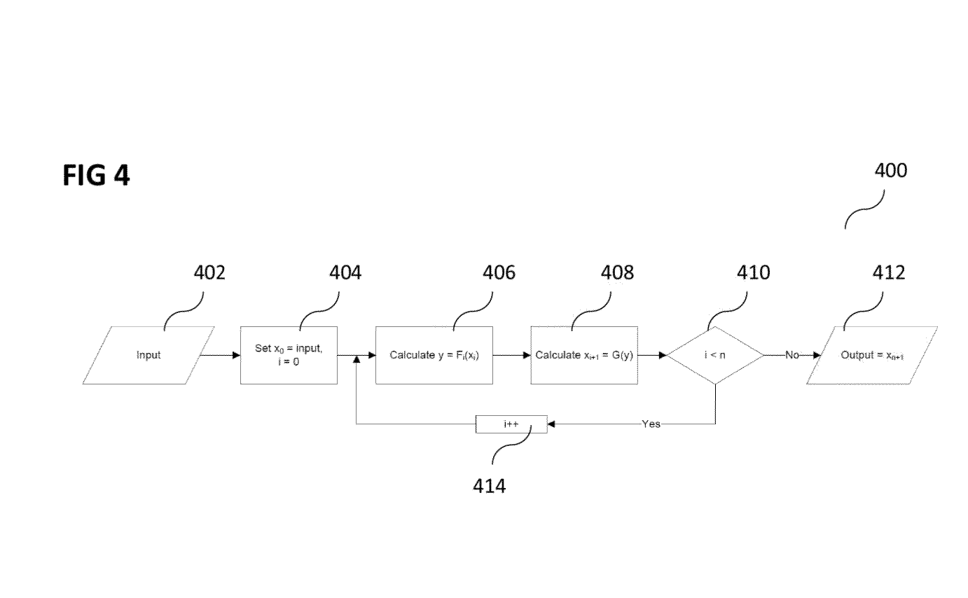

FIG. 4 shows a flowchart 400 illustrating how to use the Fᵢ and G in a hardware efficient way according to various embodiments. The input 402 may be the n-element vector x₀ (for example, in 404, x₀ may be set equal to the input, and i may be set to 0) and the output in 412 may be the n-element vector xₙ₊₁. In 406, y=Fᵢ(xᵢ) may be determined. In 408, xᵢ₊₁=G(y) may be determined. In 410, it may be checked whether i<n. If so, processing may determine in 414, where i may be increased by 1 and further processing may continue in 406. If i not less than n, processing may proceed to output xₙ₊₁ in 412.

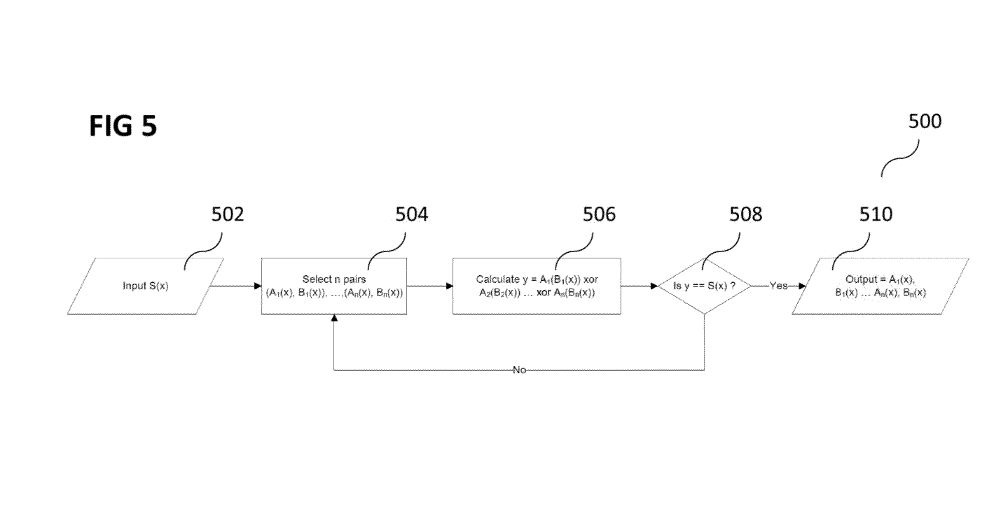

FIG. 5 shows a flow diagram 500 according to various embodiments, in which in 502, S(x) may be input.

In 504, n pairs (A₁(x), B₁(x)), . . . , (Aₙ(x), Bₙ(x)) may be chosen such that its degree are lower than that of S(x). In 506, A₁(B(x)) xor . . . xor Aₙ(Bₙ(x)) may be determined, and in 508, it may be determined whether A₁(B(x)) xor . . . xor Aₙ(Bₙ(x)) is identical to S(x). If so, processing may proceed in 510, if not, processing may proceed in 504. In 510, the vectorial boolean functions A₁(x), B₁(x), . . . , Aₙ(x), Bₙ(x) may be output.

In the following, an example of an embodiment of the decomposition method according to various embodiments for a 4×4 S-box will be described.

Consider the following example with a 4×4 S-box S(x)=(0, 1, 2, 7, 4, 5, 14, 9, 8, 11, 10, 13, 15, 12, 3, 6). Using the method according to various embodiments, it may be represented in a recursive way:

S(x)=F₄(G(y₄))

y₄=F₃(G(y₃))

y₃=F₂(G(y₂))

y₂=F₁(G(y₁))

y₁=F0(x)

where F₀(x)=F₁(x)=F₂(x)=F₃(x)=F₄(x)=x, and G(x)=(0, 2, 4, 6, 8, 10, 12, 14, 1, 3, 5, 7, 11, 9, 15, 13). In other words,

x)=G(G(G(G(x))))=G⁴(x).

According to various embodiments, the complexity may be reduced due to the reduced complexity of G(x) as compared to S(x), which may allow the heuristic synthesis tools to find more optimal solutions with less area requirements. For example, S(x) may require 19.66 Gate Equivalents (GE, which may be a normalized measure for the size of silicon required) as compared to 14.66 GE for G⁴(x), which are savings of over 25%.

Furthermore, the devices and methods according to various embodiments may allow to exploit another, previously unknown, Time-Area trade-off: In fact G(x) needs to be implemented only once in hardware, and it can be re-used in subsequent clock cycles, instead of implementing G(x) four times. Thus, for example area may be traded for time and another 75% of savings may be achieved, resulting in only 3.66 GE. In total, the devices and methods according to various embodiments thus allow to save more than 80% of the area.

In the following, an example of various embodiments for devices and methods for construction will be described for an example with a 4×4 S-box.

A very simple 4×4 s-box S(x)=(1, 2, 3, 4, 5, 6, 7, 8, 9, 10, 11, 12, 13, 14, 15, 0) with degree 3 may be considered. The three following vectorial boolean functions of degree 2:

A₁(x)=(1, 2, 3, 8, 5, 6, 7, 12, 9, 10, 11, 0, 13, 14, 15, 6),

B₁(x)=(8, 9, 4, 5, 12, 13, 2, 3, 10, 11, 6, 7, 14, 15, 0, 1),

B₂(x)=(8, 8, 6, 2, 8, 8, 6, 0, 2, 10, 12, 0, 2, 10, 12, 0)

and one vectorial boolean function of degree 1:

A₂=(0, 1, 2, 3, 4, 5, 6, 7, 8, 9, 10, 11, 12, 13, 14, 15)

may be used to construct S(x)=A₁(B1(X)) xor A₂(B₂(x)).

In the following, a survey on lightweight cryptography and differential power analysis (DPA) countermeasures will be given.

The dawning ubiquitous computing age may demand a new attacker model for the myriads of pervasive computing devices used: since a potentially malicious user is in full control over the pervasive device, additionally to the cryptographic attacks the whole field of physical attacks has to be considered. Most notably are here so-called side channel attacks, such as Differential Power Analysis (DPA) attacks. At the same time, the deployment of pervasive devices is strongly cost-driven, which prohibits expensive countermeasures. In the following, a survey will be given of a broad range of countermeasures and their suitability for ultraconstrained devices, such as passive RFID-tags will be discussed. It will be seen that adiabatic logic countermeasures, such as 2N-2N2P and SAL (super-adiabatic layer), seem to be promising candidates, because they increase the resistance against DPA attacks while at the same time lowering the power consumption of the pervasive device.

The vision of ubiquitous computing (ubicomp), which is widely believed to be the next paradigm in information technology, seems to become reality in the near future, since increasingly everyday items are enhanced to pervasive devices by embedding computing power. The mass deployment of pervasive devices promises on the one hand many benefits (e.g. optimized supplychains), but on the other hand, many foreseen applications are security sensitive (military, financial or automotive applications), not to mention possible privacy issues. With the widespread presence of embedded computers in such scenarios security is a striving issue, because the potential damage of malicious attacks also increases. Even worse, pervasive devices are deployed in a hostile environment, i.e. an adversary has physical access to or control over the devices, which enables the whole field of physical attacks. Not only the adversary model is different for ubicomp, but also its optimization goals are significantly different from that of traditional application scenarios: high throughput is usually not an issue but power, energy and area are sparse resources. Due to the harsh cost constraints for ubicomp applications only the least required amount of computing power will be realized. If computing power is fixed and cost are variable, Moore's Law leads to the paradox of an increasing demand for lightweight solutions.

In the following, the issue of lightweight side-channel countermeasures will be addressed. It will be understood that side-channel attacks target an implementation, while classical cryptanalysis targets an algorithm. A survey will be given of countermeasures on different architectural levels (cell, gate, algorithmic) and an evaluation of their suitability for constrained devices. Main metrics may be the area and timing overhead, but also practical evaluations may be taken into account to identify a set of countermeasures that seem to be promising for constrained devices.

In the following, the hardware properties of basic building blocks will be highlighted, such as Boolean operations and flip-flops, side channel attacks and several commonly used countermeasures will be described. A selection of countermeasures will be evaluated with regard to their suitability for constrained devices.

In the following, hardware properties of cryptographic building blocks will be described.

Block ciphers may take a block of data and a key as input and transform it to a ciphertext, often using a round function that is iterated several times. The intermediate state is called data state and key state, respectively. While software implementations have to process single operations in a serial manner, hardware implementations offer more flexibility for parallelization and serialization. Generally speaking there exist three major architecture strategies for the implementation of block ciphers: serialized, round-based, and parallelized. In a serialized architecture only a fraction of a single round is processed in one clock cycle. These lightweight implementations allow to reduce area and power consumption at the cost of a rather long processing time. If a complete round is performed in one clock cycle, we have a round-based architecture. This implementation strategy usually offers the best time-area product and throughput per area ratio. A parallelized architecture processes more than one round per clock cycle, leading to a rather long critical path. A longer critical path leads to a lower maximum frequency but also requires the gates to drive a higher load (fanout), which results in larger gates with a higher power consumption. By inserting intermediate registers (a technique called pipelining), it is possible to split the critical path into fractions, thus increasing the maximum frequency. Once the pipeline is filled, a complete encryption can be performed in one clock cycle with such an architecture. Consequently, this implementation strategy yields the highest throughput at the cost of high area demands. Furthermore, since the pipeline has to be filled, each pipelining stage introduces a delay of one clock cycle.

In the context of lightweight cryptography, clearly serialized implementations are the most important architecture, since they allow to significantly reduce the area and power demands. In order to compare the area requirements independently of the technology used, it is common to state the area as gate equivalents [GE]. One GE is equivalent to the area which is required by the two-input NAND gate with the lowest driving strength of the appropriate technology. The area in GE is derived by dividing the area in μm2 by the area of a two-input NAND gate. However, it is not easy to compare the power consumption of different technologies.

In order to reuse the same hardware resources in a serialized or round-based implementation, data and key state have to be stored. Since external memory is often not available for cryptographic applications or draws too much current (e.g. on passive RFID-tags), the state has to be maintained in registers using flipflops. Unfortunately flipflops have a rather large area and power demand, for example, when using the Virtual Silicon (VST) standard cell library based on the UMC L180 0.18μ 1P6M Logic process (UMCL18G212T3), flipflops require between 5.33 GE and 12.33 GE to store a single bit (see Table 1).

TABLE 1
Area requirements and corresponding gate count of
selected standard cells of the UMCL18G212T3 library

| Standard cell | Cell name | Area in μm² | GE |
|---|---|---|---|
| NOT | HDINVBD1 | 6.451 | 0.67 |
| NAND | HDNAN2D1 | 9.677 | 1 |
| NOR | HDNOR2D1 | 9.677 | 1 |
| AND | HDAND2D1 | 12.902 | 1.33 |
| OR | HDOR2D1 | 12.902 | 1.33 |
| MUX | HDMUX2D1 | 22.579 | 2.33 |
| XOR (2-input) | HDEXOR2D1 | 25.805 | 2.67 |
| XOR (3-input) | HDEXOR3D1 | 45.158 | 4.67 |
| D Flip flop | HDDFFPB1 | 51.61 | 5.33 |
| Scan D flipflop/w | HDSDFPQ1 | 58.061 | 6 |
| enable | | | |
| Scan flipflop | HDSDEPQ1 | 83.866 | 8.67 |
| complex | HDSDERSPB1 | 119.347 | 12.33 |
| Scan flipflop | | | |

The gate count differs so significantly for different cells because the first cell may consist only of a simple D flipflop itself, while the latter one includes a multiplexer to select one of two possible inputs for storage and a D flipflop with active-low enable, asynchronous clear and set. There exists a wide variety of flipflops of different complexity between these two extremes. A good trade-off between efficiency and useful supporting logic provide the two flipflop cells. Both are scan flipflops, which means that beside the flipflop they also provide a multiplexer. The latter one is also capable of being gate clocked, which is an important feature to lower power consumption. Storage of the internal state typically accounts for at least 50% of the total area and power consumption. E.g. the area requirements of storage logic accounts for 55% in the case of a round-based present and for 86% in the case of a serialized present, while for a serialized AES it accounts for 60% of the area and half of the current consumption (i.e. 52%). Therefore implementations of cryptographic algorithms for low-cost tag applications should aim to minimize the storage required.

The term combinatorial elements includes all the basic Boolean operations such as NOT, NAND, NOR, AND, OR, and XOR. It also includes some basic logic functions such as multiplexers (MUX). It is widely assumed that the gate count for these basic operations is typically independent of the library used. However, it may be shown that ASIC implementation results of a serialized present in different technologies range from 1,000 GE to 1,169 GE. This indicates that also the gate count for basic logic gates differs depending on the used standard-cell library. For the Virtual Silicon (VST) standard cell library based on the UMC L180 0.18μ 1P6M Logic process (UMCL18G212T3) the figures for selected two-input gates with the lowest driving strength is given in Table 1. It is to be noted that in hardware XOR and MUX are rather expensive when compared to the other basic Boolean operations.

In the following, background information of Differential Power Analysis attacks and their countermeasures will be introduced.

Although nowadays side-channel attacks, after the first publication of power analysis attacks, are known as a serious threat for devices performing cryptographic operations, in fact this kind of attacks has been accidentally discovered in 1943. These attacks exploit the fact that the execution of a cryptographic algorithm on a physical device leaks information about the processed data and/or executed operations through side channels, e.g., power consumption, execution time and electromagnetic radiation. As presented in a number of publications, side-channel attacks particularly power analysis attacks are considered as an extremely powerful and practical tool for breaking cryptographic devices.

By measuring and evaluating the power consumption of a cryptographic device, information-dependent leakage may be exploited and combined with the knowledge about the plaintext or ciphertext (in contrary to mathematical cryptanalyses which require pairs of plain- and ciphertexts) in order to extract, e.g., a secret key. Since intermediate results of the computations can be derived from the leakage, e.g., from the Hamming weight of the data processed in a software implementation, a divide-and-conquer strategy becomes possible, i.e., the secret key could be recovered byte by byte.

A Simple Power Analysis (SPA) attack may rely on visual inspection of power traces, e.g., measured from an embedded microcontroller of a smartcard. The aim of an SPA is to reveal details about the execution of the program flow of a software implementation, like the detection of conditional branches depending on secret information. Contrary to SPA, Differential Power Analysis (DPA) utilizes statistical methods and evaluates several power traces with often uniformly distributed known plaintexts or known ciphertexts. A DPA may require no knowledge about the concrete implementation of the cipher and can hence be applied to any unprotected black box implementation. According to intermediate values depending on key hypotheses the traces are divided into sets or correlated to estimated power values, and then statistical tools, e.g., difference of estimated means, correlation coefficient, and estimated mutual information, indicate the most probable hypothesis amongst all partially guessed key hypotheses.

Several schemes have been provided to protect cryptographic implementations against DPA attacks. A DPA countermeasure aims at preventing a dependency between the power consumption of a cryptographic device and intermediate values of the executed algorithm. Hiding and Masking are among the most common countermeasures on either the hardware or the software level. The goal of Hiding methods is to increase the noise factor or to equalize the power consumption values independently of the processed data while Masking relies on randomizing key-dependent intermediate values processed during the execution of the cipher. The most common proposed countermeasures can be classified as follows:

A) Cell Level (DPA-resistant logic styles): Counteracting DPA attacks at the cell level means that the logic cells of a circuit are implemented in such a way that their power consumption is independent of the processed data and the performed operations. During the last years, several proposals as DPA-resistant logic style have been made and a selection is given here:

A1) Sense Amplifier Based Logic (SABL), which is a dual-rail precharge logic, is designed to have a constant internal power consumption independent of the processed logic values. In order to achieve this aim, a full-custom design tool must be used to balance all the internal capacitances of the final layout.

A2) Wave Dynamic Differential Logic (WDDL) and Masked Dual-rail Precharge Logic (MDPL) have been designed to avoid the usage of a full-custom design tool. However, their implementations show strong data-dependent leakage which makes them vulnerable to straightforward DPA attacks.

A3) Random Switching Logic (RSL) employs several random bits for a non-linear combinational circuit and needs a special design flow to reach the desired level of protection. For instance a practical implementation showed vulnerability to a single-bit DPA attack.

A4) Dual-rail Transition Logic (DTL), which aims at randomly changing the logic values and presenting the desired data at the same time, has not been practically evaluated yet and its effectiveness is still uncertain.

A5) Charge Recovery Logics have been proposed for low-power applications, and some of them, so-called adiabatic logic styles, have been investigated from DPA-resistance point of view. Adiabatic logic uses a time-varying voltage source and its slopes of transition are slowed down. This reduces the energy dissipation of each transition.

In short the idea of adiabatic logic is to use a trapezoidal power-clock voltage rather than fixed supply voltage. As a consequence the power consumption of a circuit is reduced while at the same time its resistance against side-channel attacks is greatly enhanced.

B) Masking: Randomizing the values which are processed by the cryptographic device can be performed at different levels of abstraction:

B1) Gate Level: Masking at the gate level is performed by considering a number of mask bits for each logic value of the circuit. There are a number of proposals on how to use mask bits at the gate level. However, practical realization of such schemes faces with glitches which inherently happen on logic circuit and cause vulnerability to DPA attacks.

B2) Algorithm Level: According to the masking scheme, e.g., additive or multiplicative, non-linear functions of the given cipher must be redesigned to fulfill the desired level of security. There is a set of contributions on a masking scheme on the AES substitution function, e.g. Nevertheless, their practical investigations show vulnerability to those DPA attacks which consider glitches of the combinational circuit as the hypothetical power model. Moreover, there are some proposals which are provably secure. Though they have not been practically investigated, the same vulnerability to glitches is expected.

A threshold implementation of Sboxes has been provided to avoid the effect of glitches, but it has not been practically verified yet.

C) Hiding: Randomizing the amounts of power consumption in order to hide the sensitive operation is often performed on software implementations by shuffling the execution of operations and/or by insertion of dummy operations. Although this class of countermeasures can not perfectly protect against DPA attacks, its combination with algorithmic masking, provides a reasonable level of protection.

Randomly permuting intermediate values using permutation tables also can be considered as a hiding scheme, but its efficiency has been investigated as a vulnerability has been reported. Moreover, dynamic reconfiguration, can be considered as a realization of shuffling in hardware.

In the following, a comparison of countermeasures will be given. The countermeasures as described above will be evaluated with regard to the following criteria:

A) Area Overhead: The area overhead of every countermeasure is one of the most important metrics, when low-cost devices are considered, since the cost of an ASIC are proportional to its area. These figures are either obtained from the corresponding publications or estimated. Therefore they should primarily not be seen as precise figures, but rather as an indicator in what range a countermeasures is to be expected to increase the area.

B) Timing Overhead: Typically timing is not critical in many low-cost applications as only rather small amounts of data are going to be processed. However, the energy consumption is directly proportional to the amount of clock cycles required. Therefore the timing overhead is an important measure for active (i.e. battery powered) constrained devices, rather than for passive (i.e. without an own power supply) constrained devices. Similar to the area overhead these figures are either obtained from the corresponding publications or are estimated and should be viewed as rough guidelines rather than precise figures.

C) Practical Evaluation: It has turned out that countermeasures that have been shown to be provably secure by using simulated power consumption can be attacked when real ASIC implementations are used. On the other hand, theoretical attacks on simulated power consumptions have been shown to be impractical on real world ASIC implementations. Therefore practical evaluation of a countermeasure is crucial for a more precise evaluation of the security level that can be achieved with this countermeasure. Furthermore, this column is a good indicator for future work as it shows where prototyping of an ASIC has been done already.

D) Known Leakages: This column lists publications that have found theoretical or practical leakages of the countermeasure.

TABLE 2
Area and Timing overhead of several side channel countermeasures

| Countermeasure | | Overhead factor | | Pract. |
|---|---|---|---|---|
| Level | Type/Name | Area | Time | eval. |
| Cell | MDPL | 5 | 2.6 | yes |
| | iMDPL | *15 | *6 | no |
| | RSL | 2 | 2 | yes |
| | DTL | *11 | *4 | no |
| | 2N-2N2P | *2 | ⁽²⁾ | no |
| | SAL | *4 | ⁽²⁾ | no |
| Gate | Private Circuits | ⁽³⁾ | ⁽³⁾ | no |
| | Masking | *10 | *5 | no |
| Alg. | Masking | *8 | *5 | no |
| | Masking | *6 | *4 | no |
| | Masking | 2.5 | 3 | no |
| | Masking | 4 | 3 | no |
| | Secret Sharing | *3 | *1.3 | no |
| | Shuffling + Masking | 7 | 10 | yes |
| | Rand. Perm. Tab. | 2.5 | 12 | yes |
| | Dyn. Reconf. | 4.75 | 3.36 | yes |

(estimated values are denoted by*)

Table 2 shows area and timing overhead of several side channel countermeasures (wherein estimated values are denoted by *). It is to be noted that the overheads vary by different algorithms and architectures. The values presented in this table are mostly based on implementations of the AES encryption algorithm, and we did our best to consider the same architecture for all countermeasures. Fields in table 2 indicated by (2) indicate that the countermeasure may be suitable for low-throughput applications. Fields in table 2 indicated by (3) indicate that the value depends on the level of protection, e.g., area overhead would be an order of O(nt²), where n is the size of the original circuit and t is related to the desired protection level.

In the following some notes on Table 2, which summarizes a comparison between the most promising countermeasures, are given. MDPL has only around half the speed, because MDPL gates consist of two P-N networks due to the usage of majority gates, i.e., a basic majority cell followed by an inverter. Area overhead ranges from 2 for a buffer, over 3.5 for a D-type flipflop and up to 6 for an XNOR gate. A prototyped ASIC implementation of the AES resulted in an area overhead factor of around 5, a power overhead factor of 11 and a timing overhead factor of 2.6. Several leakages have been found for MDPL and a chip has been prototyped and evaluated. Finally, there has been proposed an improved MDPL, called iMDPL. However, iMDPL requires 3 times more area than MDPL, thus increasing the total area overhead factor to around 15, i.e. an implementation in iMDPL is around 15 times larger than a plain CMOS implementation. Furthermore, the leakages also hold for iMDPL.

RSL may double the area requirements while halving the speed for the maximum frequency, since timing is not critical, there can no delay be expected in low frequency typical for low-cost devices. However, after prototyping an ASIC a leakage has been reported.

Charge recovery logics, e.g., 2N-2N2P and SAL, increase the area by a factor between 2 and 4. However, the power consumption is less than for standard CMOS circuits. Since their DPA-resistance increases with lower frequencies, it makes them particular valuable for low-power low throughput applications, such as passive RFID-tags. No charge recovery logic has been yet practically evaluated and no leakages have been fund so far. It seems to be one of the most promising candidates for future evaluation. However, since it is a full-custom design no standard-cell design flow can be used.

All gate-level masking schemes have been shown to be susceptible in the presence of glitches and thus are not considered any further by us. Moreover, algorithmic masking approaches are susceptible to toggle count attacks.

Canright algorithmic masking yields a very compact S-box of the AES that is 2.7 times as large as an unprotected S-box for the first round and 2.2 times larger for every subsequent round. A masked AES implementation would require to also store the mask bits which would double the area requirements for storage. All together the area overhead factor is estimated to be 2.5. Since it has not yet practically evaluated it seems to be an interesting candidate for further investigations, especially its resistance to glitching attacks. Zakeri algorithmic masking also increases the area by a factor of around 4, which is rather large. However, there has been no practical evaluation so far and no leakage has been found.

Nikova algorithmic masking based on secret sharing has not been practically evaluated so far. It requires to store at least two additional mask bits for every masked bit. Given the fact that especially in lightweight implementations storage accounts for the majority of the gate count, it is fair to estimate the hardware overhead with a factor of 3. However, this countermeasures has not been practically evaluated and seems to be an interesting candidate for future investigations.

Dynamic reconfiguration increases the area requirements by a factor of 4.75 and reduces the maximum clock frequency by a factor of 3.36. However, since lightweight applications typically do not need high throughput the timing overhead is not important, but the area overhead is already rather high.

The structural problem of most of today's SCA countermeasures is that they significantly increase the area, timing and power consumption of the implemented algorithm compared to an unprotected implementation. Furthermore, many countermeasures require random numbers, hence also a TRNG (True Random Number Generator) or a PRNG (Pseudo Random Number Generator) has to be available. Since this will also increase the cost of an implementation of the algorithm, it will delay the break-even point and hence the mass deployment of some applications. For ultra-constrained applications, such as passive RFID tags, some countermeasures pose an impregnable barrier, because the power consumption of the protected implementation is much higher than what is available.

Power optimization techniques are an important tool for lightweight implementations of specific pervasive applications and might ease the aforementioned problem. On the one hand they also strengthen implementations against side channel attacks, because they lower the power consumption (the signal), which decreases the signal to noise ratio (SNR). However, on the other hand power saving techniques also weaken the resistance against side channel attacks. One consequence of the power minimization goal is that in the optimal case only those parts of the data path are active that process the relevant information. Furthermore, the width of the data path, i.e. the amount of bits that are processed at one point in time, is reduced by serialization. This however implies that the algorithmic noise is reduced to a minimum, which reduces the amount of required power traces for a successful side channel attack. Even worse, the serialized architecture allows the adversary a divide-and-conquer approach which further reduces the complexity of a side channel attack. Summarizing, it can be concluded that lightweight implementations greatly enhance the success probability of a side channel attack. The practical side channel attack on KeeLoq applications impressively underline this conclusions.

Adiabatic logics, like other DPA countermeasures, have an area overhead, but decrease the (instantaneous) power consumption by decreasing the frequency. As a consequence the resistance of the corresponding circuit against side-channel attacks is extremely increased. Especially for pervasive devices adiabatic logic styles seem to be a promising SCA countermeasure and practical evaluations of these logic styles will be worth reading. Furthermore, an approach with a moderate area overhead and which was theoretically proven to be secure against DPA attacks is provided.

Many hardware countermeasures against Side-Channel Attacks (SCA) have been proposed on the Cell, Gate and the Algorithmic Level. In Table 2 above, a comparison of commonly used hardware countermeasures with regard to Area overhead (and thus cost and power consumption), time overhead and security level is described. If the last column cites some references it means that a theoretical problem has been identified with the countermeasure, while “practical evaluation” means it has been demonstrated in practice that this countermeasure can be broken.

The Secret Sharing countermeasure (also called Threshold Implementation, TI) has one of the lowest area and timing overheads, while so far no leakage has been identified, and consequently no practical evaluation has been reported. In fact, it may be shown, that the area overhead is even less (a factor of around 2.2). This makes this countermeasure very competitive as compared to the other hardware countermeasures.

On the other hand, the TI countermeasure is algorithmic-dependent, and hence has to be adapted to the target algorithm individually. Current research can so far apply this countermeasure only to 50% of all 4-bit S-boxes (using the minimal number of shares, i.e., three), and hence only algorithms which use one of these building blocks.

According to various embodiments, devices and methods may be provided which overcome the aforementioned shortcomings of the TI countermeasure. Devices and methods according to various embodiments may allow:

1) to apply the TI countermeasure to all 4-bit S-boxes;

2) to significantly decrease the area requirements of S-boxes; and

3) to significantly decrease the area requirement of the substitution layer of block ciphers using different S-boxes, e.g. SERPENT.

Examples 3)+4) may be especially efficient when used in combination with the TI countermeasure, but it may also be applicable to all Boolean Functions, regardless if protected by the TI countermeasure or not.

In the following, a 3-share threshold implementation countermeasure to any 4-bit sbox according to various embodiments will be described.

Threshold Implementation (TI) may be an elegant and important countermeasure against the 1-st order Differential Power Analysis (DPA) in Side Channel Attack. The 3-share TI applied for PRESENT's s-box may not only be cheap but also efficient and useful due to its methodology. In the following, the pipeline structure and factorization structure which makes the 3-share TI applicable to any 4-bit optimal s-box will be described. According to various embodiments, devices and methods may be provided which may decompose any 4-bit optimal s-box with 2¹⁹ time complexity. Additionally, these structures according to various embodiments may be used to optimize the construction a cipher utilizing many different optimal s-boxes. Furthermore, the protected s-boxes of SERPENT block cipher are studied.

Side Channel Attack may be the attack to the cryptographic algorithm based on the physical information which may be collected during the algorithm processes. This side information may be any kind of physical information such as timing information, power consumption, electromagnetic, or the sound. Based on this side information, the secret key may be recovered quickly. One of the most powerful attacks in side channel attack may be differential power analysis (DPA). DPA attack may be used to recover secret key by using multiple power traces. A power trace may be the record of power consumption of cryptographic algorithm when it processes a data input for example a plaintext. If a cryptographic algorithm is not equipped a countermeasure against DPA, then it is vulnerable to this attack.

A countermeasure against the 1-st order DPA may be called threshold implementation (TI). The TI may be a masking countermeasure which is based on secret sharing and multi-party computation methods. While a normal masking countermeasure against DPA does not work due to the presence of glitches, this countermeasure may not only still be valid but also easily to be implemented. The protected 4-bit s-box of PRESENT block cipher may be implemented with 3-share TI countermeasure to resist against the 1-st order DPA. Indeed, this countermeasure implementation may be very cheap and elegant in terms of working. The 3-share TI may be the smallest number of shares in TI countermeasure and the input data may be needed to be masked at very beginning. Then, the masked data may be unmasked in the end of encryption or decryption. The processed data may not need to be unmasked and re-masked for each round in encryption. It implies that the TI countermeasure is very elegant in usage.

Nowadays, 4-bit sboxes may be used in cryptographic algorithm due to its tiny hardware implementation. A 4-bit s-box may be suitable to light weight cryptographic algorithm. Actually, a 4-bit s-box may be a 4-bit permutation. A set of 4-bit s-boxes which fulfill all the cryptographic security requirements may be studied, i.e. they have to resist well against the linear cryptanalysis and differential cryptanalysis. These s-boxes may be called optimal one. The PRESENT's s-box may be a 4-bit optimal one and based on the Pipeline structure it can be equipped with 3-TI countermeasure. According to various embodiments, it may be studies that what the optimal s-boxes are suitable to 3-share TI based on Pipeline structure. According to various embodiments, it may be shown that all the 4-bit optimal s-boxes which are in alternating group A₁₆ of symmetric group S₁₆ are able to be equipped with 3-TI countermeasure based on Pipeline structure. This may imply that we can not apply 3-TI to those s-boxes which are not in A₁₆ in Pipeline structure. The Factorization structure may be introduced based on which all the 4-bit optimal s-boxes may be protected by using 3-TI countermeasure. Additionally, by using two these structures, the hardware implementation of a certain cryptographic algorithm may be optimized. Especially, it may be useful in case a block cipher uses many s-boxes. According to various embodiments, SERPENT cipher may be used as a sample. In this cipher, there are four 4-bit optimal s-boxes belonging to A16 and four 4-bit optimal s-boxes are not in A16. For those s-boxes not in A16, there may be no method to apply 3-TI countermeasure unless Factorization structure is appealed. And by using a deep investigation into these structures, the hardware implementation of SERPENT cipher may be reduced.

Moreover, finding a decomposition or factorization of an arbitrary optimal s-box may not be a trivial problem. Sometime, the time complexity may be more than 2̂{52} or might be beyond an available capacity. Indeed, the 2̂{52} time complexity may still a challenging problem. To solve this problem, firstly according to various embodiments, the structure of optimal s-boxes may be studied and then, a method may be derived which may not only decompose any optimal s-box with 2¹⁹ time complexity, but also very efficient in terms of hardware implementation.

In the following, the Threshold Implementation countermeasure and results will be described, the 4-bit optimal s-boxes which are suitable to 3-TI countermeasure based on Pipeline Structure will be described, and the factorization structure will be described. Furthermore, the application of two these structures will be described together with the protected SERPENT cipher.

In the following, a threshold implementation countermeasure will be described.

The Threshold Implementations (TI) may be introduced as a kind of side channel attack countermeasure. It may be used to resist against the 1-st order DPA based on the secret sharing and multiparty computation methods even if the presence of glitches exists. Let denote by small characters x, y, z, . . . stochastic variables and by capital X, Y, . . . samples of these variables. The probability that x takes the value X is denoted by Pr(x=X). The method can be described as follows. The variable x is divided into s shares xᵢ, 1≦i≦s, such that x=⊕ᵢ₌₁^{s}xᵢ. Let F(x,y, z . . . ) be a vectorial boolean function which needed to be shared. Denote x̅ᵢ̅=(x₁, . . . , xᵢ₋₁, xᵢ₊₁, . . . , xₛ,), i.e, the vector x̅ᵢ̅ does not contain the share xᵢ. In order to share F, a set of s vectorial boolean functions Fᵢ is constructed and fulfill three following properties:

1. Non-completeness: All the functions Fi must be independent to the input variables x, y, z, . . . , i.e the inputs of Fi does not have xi, yi, zi or Fᵢ=Fᵢ( x̅ᵢ̅).

2. Correctness: F(x, y, z, . . . )=⊕ᵢ₌₁^{s} Fᵢ( x̅ᵢ̅, y̅ᵢ̅, z̅ᵢ̅, . . . ) and if the inputs satisfy the following condition

$$Pr ( \text{?} = \text{?} , \text{?} = \text{?} , … ) = q \times Pr ( x = \text{?} {X}_{i , y} = \text{?} {Y}_{i} , … )$$

$$\text{?} \text{indicates text missing or illegible when filed}$$

then the shared function F resists first order DPA even in the presence of glitches where q is a constant.

In general, the output of F can be a input of a nonlinear function. Hence, the following property for the output of F is required in order to make the cipher resistant against 1-st order DPA in presence of glitches. Assume that output of F is (u, v, w . . . ) and

$$\text{?} = {⊕}_{i = 1}^{s} \text{?} , \text{?} = ( {u}_{1} , \text{?} , … , {u}_{s} ) , \\ \text{?}$$

$$\text{?} \text{indicates text missing or illegible when filed}$$

then the third property is defined as follows.

3. Uniformity: A shared version of F is uniform if

$$Pr ( \text{?} = \text{?} , … , \text{?} = \text{?} ) = q \times \text{?} ( \text{?} = \text{?} \text{?} , … , \text{?} = \text{?} \text{?} ) \\ \text{?} \text{indicates text missing or illegible when filed} \qquad$$

where q is a constant.

The number of shares s depends on the degree of the original vectorial boolean function F(x, y, z, . . . ). Assume that the degree of F is d, then s is computed as follows:

Theorem 1. The minimum number of shares required to implement a product of d variables with a realization satisfying Property 2 and 1 is given by

s≧1+d.

Since the minimum degree of a nonlinear vectorial boolean function is 2, the number of shares s is at least 3 and the more shares is needed, the bigger hardware implementation is. Therefore, the 3-share is the most interesting case.

In the following, a 3-share TI in 4-bit s-boxes will be described.

3-share TI is the most interesting application in Threshold Implementation Countermeasure due to its low hardware implementation cost and nice usage methodology. In using Threshold Implementation as a countermeasure, people only mask the input data at very beginning. Then, the masked data is not needed to be unmasked and re-masked in each round. Therefore, this is the most beautiful point in terms of usage methodology in comparison to the other countermeasures. The 3-share TI is the most optimal TI countermeasure in terms of number of shares used. Hence, the hardware implementation is cheap and it leads to the reduction of power usage. Therefore, this countermeasure is very efficient and suitable to be used in lightweight ciphers.

Since the limitation in hardware area of lightweight block ciphers, the s-box is required to be not only small and easy to be implemented but also meet some certain security requirements. 4-bit optimal s-boxes may be suitable to fulfill these requirements.

In the following, decomposing a cubic s-box in composition of two quadratic permutations or the case of protected PRESENT's s-box by using 3-share TI will be described. Since the PRESENT's s-box S(•) is 4-bit cubic permutation, the 4-share TI may be applied if it is desired to directly apply TI countermeasure to this s-box. In order to utilize 3-share TI, this s-box may to be described in composition of two quadratic permutations S(•)=F(G(•)) (as illustrated in the FIG. 2):

S(X)=F(G(X)) where S,F,G:GF(2)⁴→GF(2)⁴.

FIG. 2 shows a composition of an S-box, for example PRESENT's s-box.

In the following, a pipeline structure according to various embodiments will be described. The 4-bit optimal s-boxes which may be equipped with 3-TI based on the pipeline structure will be described.

In the following, a decomposability of a cubic s-box in composition of two quadratic permutation will be described.

If it is desired to apply the 3-share TI to 4-bit cubic s-box, then this s-box may be replaced by a composition permutation of several quadratic permutation, i.e. in Pipeline structure. According to various embodiments, it may be determined which 4-bit cubic permutations (or s-boxes) may be constructed in Pipeline structure.

According to various embodiments, it will be shown that those 4-bit cubic permutations (or s-boxes) above must belong to A₁₆, i.e. the alternating group of symmetric group S₁₆. We recall some properties of a permutation in S₁₆.

Lemma 1. A₁₆ is a subgroup of S₁₆, i.e. if p₁(•) and p₂(•) are permutations in A₁₆ then its composition permutation p₃(•)=p₁(p₂(•)) must be in A₁₆ as well.

Lemma 2. All the linear and quadratic permutations in S₁₆ are in A₁₆.

Proof: It may be shown that there are around 2̂{26} quadratic permutations. Since the number of the linear and quadratic permutations is not big, we the permutation parity of all these permutations may be checked. The parity of a permutation tells that if a permutation has a parity +1 then it belongs to A₁₆ (or even permutation). If its permutation parity is equal −1, then it is not in A₁₆ (or odd permutation). All the considered permutations have the parity +1. It implies that these permutations belong to A₁₆.

Theorem 2. If a permutation p(•) is able to be presented as a compositions of quadratic permutations, then p(•) is in A₁₆.

Proof: The theorem is directly derived from the lemma 1 and lemma 2.

Note 1. It is to be noted that the composition of a quadratic permutation and a linear permutation is a quadratic one. Hence, a quadratic permutation is able to be described as a composition of linear and quadratic permutations.

In the following, optimal 4-bit s-boxes will be described.

An s-box may be considered as an optimal one if it fulfills pre-determined requirements. The optimal s-boxes may be importance in designing cryptographic ciphers. There may be 16 classes of linearly equivalent s-boxes in S₁₆. In the following, a study in those classes will be described.

Definition 1. Two sboxes S(x); S′(x) are linearly equivalent if (in other words: if and only if) there exist two 4×4-bit invertible matrices A;B and two 4-bit vectors c; d such that

S′(x)=A(S(Bx⊕c)⊕d), ∀x ∈ {0, . . . , 15}

Based on the Note 1, if the representative of a considered class is able to be described in Pipeline structure, then so are all the s-boxes in this class.

After checking the permutation parity of all class representatives, these classes are as follows: 0, 1, 2, 4, 5, 7, 8, 13. For example, the PRESENT s-box may be able to be described in Pipeline structure because it belongs to class 1.

After describing the given s-box in composition of several 4-bit quadratic permutations, it may be desired to convert each 4-bit quadratic permutation into a 12-bit quadratic permutation. These 12-bit quadratic permutations have to fulfill all 3 requirements of Threshold Implementations, i.e. non completeness, correctness and uniformity properties.

Definition 2. A 4-bit linear or quadratic permutation is called sharable if it can be converted to a 12-bit permutation, and this 12-bit permutation fulfills all 3 following properties: correctness, un-completeness and uniformity of Threshold Implementation. It is to be noted that, all the linear permutations are sharable.

Definition 3. A 4-bit permutation is called decomposable if it can be described as a composition of several sharable permutations.

According to various embodiments, it may be proved that all the s-boxes of classes 0, 1, 2, 4, 5, 7, 8, 13 are decomposable s-boxes. In order to prove this, we may be show that there exist decomposable s-boxes in each class. All 4-bit linear permutations can be converted 12-bit permutation which also fulfill the 3 requirements of Threshold Implementation. Therefore, all the s-boxes of these 8 classes are decomposable.

In order to an arbitrary s-box is able to be decomposed, firstly it must belong to A₁₆. Then its decomposition may be shown. It may not always be true that any s-box S(•) can be decomposed into two quadratic permutations F(G(•)). Sometime, it has to appeal at least three quadratic permutations F(•), H(•), G(•) such that S(•)=F(H(G(•))). Even if we know that the s-box has to be decomposed into three quadratic permutations, the time complexity for finding that solution F(•), H(•), G(•) is very high, i.e more than 2̂{52} time complexity. In special cases, like for the s-boxes in class 5, there might be used at least four quadratic permutations. Hence, we can not find the composition of the given s-box.

So, we need an efficient method which can quickly give out the decomposition of an arbitrary optimal s-box in A₁₆. The following lemma according to various embodiments may not only solve this problem but may also give the deep insight into the decomposition of a s-box.

Lemma 3. Let Fᵢ(•), 1≦I≦4, be sharable permutations. Then,

1. For any optimal s-boxes S(•) in classes 0, 1, 2, 8, there exist sharable permutations F₁(•) and F₂(•) such that S(•)=F₁(F₂(•)), i=0, 1, 2, 8.

2. For any optimal s-boxes S(•) in classes 4, 7, 13, there are no sharable permutations F₁(•) and F₂(•) such that S(•)=F₁(F₂(•)) but there exist F₁(•), F₂(•), F₃(•) such that S(•)=F₁(F₂(F₃(•))), i=4, 7, 13.

3. For any optimal s-boxes S(•) in class 5, there are no sharable permutations F₁(•) and F₂(•) such that S(•)=F₁(F₂(•)) but there exist F₁(•), F₂(•), F₃(•), F₄(•) such that S(•)=F₁(F₂(F₃(F₄(•)))).

Proof. The lemma is proved based on the definition 1 and Note 1. Assume that the s-box S(•) is in class i, and its decomposition is known. It is always true that by using the transformation in definition 1 and Note 1, we can derive a decomposition of any s-box which is in class i as well. Moreover, if S(•) can not be decomposed, for example in F₁(F₂(•)), then it implies that all the s-boxes in class i, can not be decomposed as well.

According to various embodiments, it has been found that there exist F₁(•) and F₂(•) such that F₁(F₂(•)) belong to class 0, 1, 2 and 8. We found that the class representatives of class 4, 7, 13, and 5 can not be decomposed in F1(F2(•)) but there exist there exist F₁(•), F₂(•), F₃(•), F₄(•) such that S(•)=F₁(F₂(F₃(•))) belong to class 4, 7, 13 and S(•)=F₁(F₂(F₃(F₄(•)))) in class 5. According to various embodiments, the concrete F₁(•), F₂(•), F₃(•), F₄(•) will be provided as will be described below.

Based on lemma 3, we can decompose any given optimal s-box in A₁₆ with complexity 2¹⁹. Additionally, according to various embodiments, the following theorem may be provided:

Theorem 3. All s-boxes which belong to classes 0, 1, 2, 4, 5, 7, 8, 13 are decomposable.

Based on the theorem 2, if a 4-bit optimal s-box is applicable for 3-share TI in Pipeline structure, then it belongs to A₁₆. There are 8 remaining classes out of 16 classes with theirs representatives not belong to A₁₆. It implies that all the s-boxes in these 8 classes are not decomposable, i.e we can not protect these s-boxes by using 3-share TI in pipeline structure. According to various embodiments, the question whether there is any another structure which is not pipeline structure and based on this the 3-share TI is applicable to those 8 remaining classes may be answered.

In the following, another structure according to various embodiments will be introduced which may be used for solving this question.

In the following, a factorization structure will be described.

The representatives of 8 remaining classes, i.e classes 3, 6, 9, 10, 11, 12, 14, 15, are odd permutations (not in A₁₆). Hence, these representatives are not in A₁₆ and then can not be decomposable. Firstly, we recall two following lemmas, then we describe a solution of this problem according to various embodiments.

Lemma 4. The composition of an odd permutation and an even permutation is an odd permutation.

Proof. It is always true.

Lemma 5. The 4-bit cubic permutation α(x)=(x+1)% 16, 0≦x≦15, i.e α(•) is modulo-addition over finite field F₁₆, is an odd permutation.

Proof. The permutation parity of α(•) is −1. It implies that α(•) is an odd permutation.

Denote Gᵢ(•) the representatives of class i and Hᵢ(•) permutations such that Gᵢ(•)=α((Hᵢ(•)), i=3, 6, 9, 10, 11, 12, 14, 15. According the lemmas 4 and 5, Hᵢ(•) are even permutations.

According to various embodiments, the question above may be solved as follows:

First it may be proven that all Hᵢ(•) are decomposable.

Then the Factorization Structure may be introduced.

By using this structure, the permutation α(•) may be made factorizable. The permutation may be called factorizable if it can be constructed by using several sharable vectorial boolean functions. It implies that all the Gᵢ(•) are factorizable as well.

Since all the linear permutations are sharable, all the s-boxes of 8 classes: 3, 6, 9, 10, 11, 12, 14, 15 are factorizable.

It means that 3-share TI may be applied to all these s-boxes. It is to be note that decomposable s-boxes is a subset of factorizable s-boxes.

Lemma 6. For all Hᵢ(•) above, there is no sharable permutations F(•), G(•) such that Hᵢ(•)=F(G(•)) but there exist F(•), G(•) such that Hᵢ(•)=F(G(G(•))).

Proof. We found that there are no quadratic permutations F(•), G(•) such that Hᵢ(•)=F(G(•)) based on brute force. In the Table 3 the sharable permutations F(•), G(•) such that Hᵢ(•)=F(G(G(•))) may be provided. The permutations F(•) (or G(•)) are written in a sequence of 16 hexadecimal digits. For example in case H₃, F=de07f8213ba659c4 means

F=[0xd, 0xe, 0x0, 0x 7, 0xf, 0x8, 0x2, 0x1, 0x3, 0xb, 0xa, 0x6, 0x5, 0x9, 0xc, 0x4]

or

F=[13, 14, 0, 7, 15, 8, 2, 1, 3, 11, 10, 6, 5, 9, 12, 4].

TABLE 3
The F and G for Hᵢ

| Hᵢ | F | G |
|---|---|---|
| 3 | de07f8213ba659c4 | 8c04159d72fa63eb |
| 6 | fe70d812396a5b4c | 8c04159d63eb72fa |
| 9 | 163d47f52a98c0eb | 03268cea7351bfd9 |
| 10 | 163d47f52a98c0eb | 0d481c5937eb26fa |
| 11 | 14a9de0523f8cb76 | 028aec64935fb17d |
| 12 | 1a95d04e68b2f73c | 039b128a5ed74fc6 |
| 14 | 1af5b04e862d79c3 | 038a129bf57ce46d |
| 15 | 10fd287e9c35a4b6 | 0a1b39295647fdec |

In the following, a factorization structure will be described.

According to various embodiments, the following observation may be mode. For any given vectorial boolean function S(•), it may always be written as follows:

S(•)=U(•)⊕V(•),

where ⊕ is the bitwise operation (for example bitwise addition) and U(•), V(•) are vectorial boolean function as well. This structure may be called Factorization Structure.

According to various embodiments, S(•) may be a 4-bit cubic permutation, or an optimal s-box. S(•) may be constructed by using at least 3 quadratic vectorial boolean function as follows:

Finding 2 vectorial boolean functions F(•), G(•) such that

1. U(•)=F(G(•));

2. all the cubic terms in ANF (algebraic normal form) of S(•) are the cubic terms in that of U(•), i.e F(G(•)).

The vectorial boolean function V(•) is computed as V(•)=S(•)⊕U(•).

It is to be note that due to the uniformity Property of Threshold Implementation, G(•) may always be chosen to be a 4-bit permutation, i.e a sharable permutation.

Definition 4. A 4-bit vectorial boolean function is called sharable if it can convert to 12-bit vectorial boolean function which fulfills the correctness and uncompleteness properties of Threshold Implementation. Indeed, it is true that all the 4-bit vectorial boolean functions are able to convert to such 12-bit one. It means, all the 4-bit vectorial boolean function are sharable.

Definition 5. A 4-bit permutation is called factorizable if it can be constructed by using several sharable vectorial boolean functions and its 12-bit converted vectorial boolean function is a 12-bit permutation.

Denote (α1, α2, α3, α4)=α(x, y, z, w), where x, y, z, w, αᵢ, 1≦I≦4, are in F₂. The ANF of α is

α₁=x ⊕ yzw

α₂=y ⊕ zw

α₃=z ⊕ w

α₄=w ⊕ 1

Now, we show that the permutation α(•) is factorizable. In order to factorize α(•)=F(G(•)) ⊕ V (•), we use 3 sharable vectorial boolean functions (a; b; c; d)=G(x; y; z;w) (a sharable permutation), (A;B;C;D)=F(a; b; c; d) and (X; Y;Z;W)=V (x; y; z;w) as follows:

ANF of G(•):

a=x ⊕ yz

b=y

c=z

d=w

ANF of F(•):

A=ad

B=0

C=0

D=0

and ANF of V (•):

X=x ⊕ xw

Y=y ⊕ zw

Z=z ⊕ w

W=w ⊕ 1

The construction of the 12-bit permutation α₁₂(•) of α(•) according to various embodiments may be as follows. It may be proven that α₁₂(•) is a 12-bit permutation. Based on F(•), G(•), V (•), the 12-bit permutation α₁₂(•) of α(•) is constructed as follows:

The four bit inputs x, y, z, w are shared in 3-share, i.e x=x₁ ⊕ x₂ ⊕ x₃, y=y₁ ⊕ y₂ ⊕ y₃, z=z₁ ⊕ z₂ ⊕ z₃, w=w₁ ⊕ w₂ ⊕ w₃. So twelve bit inputs may be x₁, x₂, x₃, y₁, y₂, y₃, z₁, z₂, z₃, w₁, w₂, w₃.

The ANF of 12-bit G₁₂(•) of G(•) is:

a₁=x₂ ⊕ y₂z₂ ⊕ y₂z₃ ⊕ y₃z₂

a₂=x₃ ⊕ y₂z₃ ⊕ y₁z₃ ⊕ y₃z₁

a₃=x₁ ⊕ y₁z₁ ⊕ y₁z₂ ⊕ y₂z₁

b₁=y₂

b₂=y₃

b₃=y₁

c₁=z₂

c₂=z₃

c₃=z₁

d₁=w₂

d₂=w₃

d₃=w₁

The ANF of 12-bit F₁₂(•) of F(•) may be:

A₁=a₂d₂ ⊕ a₂d₃ ⊕ a₃d₂

A₂=a₃d₃ ⊕ a₁d₃ ⊕ a₃d₁

A₃=a₁d₁ ⊕ a₁d₂ ⊕ a₂d₁

B₁=0

B₂=0

B₃=0

C₁=0

C₂=0

C₃=0

D₁=0

D₂=0

D₃=0

The ANF of 12-bit V₁₂(•) of V(•) may be:

X₁=x₂ ⊕ x₃w₃ ⊕ x₂w₃ ⊕ x₃w₂

X₂=x₃ ⊕ x₁w₁ ⊕ x₁w₃ ⊕ x₃w₁

X₃=x₁ ⊕ x₂w₂ ⊕ x₁w₂ ⊕ x₂w₁

Y₁=y₂ ⊕ z₃w₃ ⊕ z₂w₃ ⊕ z₃w₂

Y₂=y₃ ⊕ z₁w₁ ⊕ z₁w₃ ⊕ z₃w₁

Y₃=y₁ ⊕ z₂w₂ ⊕ z₁w₂ ⊕ z₂w₁

Z₁=z₂ ⊕ w₂

Z₂=z₃ ⊕ w₃

Z₃=z₁ ⊕ w₁

W₁=w₂ ⊕ 1

W₂=w₃

W₃=w₁

Then α₁₂(•)=F₁₂(G₁₂(•)) ⊕ V₁₂(•) is a 12-bit permutation.

Since α₁₂(•) is a 12-bit permutation, α₁₂(•) is factorizable. Therefore, all representatives of 8 classes 3, 6, 9, 10, 11, 12, 14, 15 are factorizable as well. It implies that all the optimal s-boxes in these classes are factorizable. Therefore, we can apply the 3-share TI for these s-boxes.

It is to be noted that we can directly construct the 12-bit permutation S₁₂(•) of a given 4-bit cubic s-box S(•) by using the same way for α(•). It means that α(•) is an instruction of using the Factorization Structure for applying the 3-share TI. It is very clear that the Pipeline structure is a special case of Factorization structure.

Theorem 4. All 4-bit optimal s-boxes in symmetric group S₁₆ are factorizable. It implies that all these s-boxes can be protected by using the 3-share TI.

In the following, applications based on pipeline structure and factorization structure according to various embodiments will be described.

In the definition 1, if S and S′ belong to the same class i, then two those s-boxes can share the same core, i.e. Gᵢ. It implies that, the hardware implementation of both s-boxes is reduced by using only one core Gᵢ. If two s-boxes are not linearly equivalent, then they can not share one core. In the light weight cipher, the hardware implementation is required to be small. In the following, it will be described how the pipeline structure and factorization structure can achieve this goal. It will be described by using the SERPENT cipher because this cipher has 8 s-boxes S₀, . . . , S₇. Half of those s-boxes belong to A₁₆ and in different classes and the remaining s-boxes are not in A₁₆ and in different classes as well. All the results according to various embodiments are available to unprotected or protected s-box.

Let S˜S′ denote that S is linearly equivalent to S′ and Gᵢ the representative of class i. We write the 4×4-bit matrix A in the hexadecimal, for example:

$$A = ( \begin{matrix}1 & 0 & 1 & 0 \\ 0 & 1 & 0 & 0 \\ 1 & 0 & 0 & 0 \\ 1 & 0 & 1 & 1\end{matrix} ) = ( \begin{matrix}a \\ 4 \\ 8 \\ b\end{matrix} ) = ( 0 \times b 84 a ) \qquad ( 1 )$$

In the following, S-boxes in SERPENT cipher will be described. The SERPENT cipher has 8 sboxes S₀, . . . , S₇ as follows:

S₀˜G₂

S₁˜G₀

S₂˜S₆˜G₁

S₃˜S₇˜G₉

S₄˜S₅˜G₁₄ (2)

The 5 cores G₀, G₁, G₂, G₉, G₁₄ may be desired to be implemented. This implementation may be big even in unprotected cipher. According to various embodiments, the number of cores may be reduced by exploiting the Pipeline Structure and Factorization Structure according to various embodiments.

In the following, using the Pipeline Structure according to various embodiments to reduce the number of cores will be described.

Let G be the following sharable permutation:

G=[0, 4, 1, 5, 2, 15, 11, 6, 8, 12, 9, 13, 14, 3, 7, 10].

Attention may be paid on the very special case of Pipeline Structure according to various embodiments:

S(•)=AₙF(Aₙ₋₁F( . . . A₀(F(•)) . . . )

where Aₙ, . . . , A₀ are invertible matrices and S(•), F(•) are two vectorial boolean functions. In this structure, F(•) only may need to be implemented once instead of n times of that. Additionally, it will be shown that this special structure according to various embodiments helps to reduce the number of cores. According to various embodiments, we have the following observation:
1. if A=0x1249, then S(•)=G(AG(•))˜G₀
2. if A=0x1248, then S(•)=G(AG(•))˜G₁
3. if A=0x1259, then S(•)=G(AG(•))˜G₂
4. if A=0x1295, then S(•)=G(AG(•))˜G₈
5. if A=0x12c6, then S(•)=G(AG(G(•)))˜G₄
6. if A=0x1843, then S(•)=G(AG(G(•)))˜G₇
7. if A=0x134b, then S(•)=G(AG(G(•)))˜G₁₃
8. if A=0x14a7, then S(•)=G(AG(G(G(•))))˜G₅

Based on this results, instead of constructing 3 big cores G0, G1, G2 for 4 s-boxes S0, S1, S2, S6, only G(•) and the matrices 0x1249, 0x1248 and 0x1259 may be needed to be implemented. Then, the transformation in definition 1 may be used to construct 4 s-boxes S0, S1, S2, S6 and the needed parameters of those s-boxes are provided in Table 4. Additionally, this observation may be used to support to theorem 3 as well.

TABLE 4
The parameters A, B, c, d of s-boxes S₀, S₁, S₂, S₆ of SERPENT

| | A | B | c | d | class |
|---|---|---|---|---|---|
| SERPENT S₀ [1] | 0x4659 | 0x3f98 | 0xa | 0x2 | 2 |
| SERPENT S₁ [1] | 0xd597 | 0xc43a | 0xf | 0x8 | 0 |
| SERPENT S₂ [1] | 0xbd87 | 0x2418 | 0xe | 0x1 | 1 |
| SERPENT S₆ [1] | 0x5978 | 0xce96 | 0x7 | 0xa | 1 |

Moreover, we also have the following observation according to various embodiments, which provides the optimal implementation for the protected s-boxes which are not in A₁₆.
1. if A=0x13c6, then S(•)=G(AG(G(•)))˜H₃
2. if A=0x13c4, then S(•)=G(AG(G(•)))˜H₆
3. if A=0x1529, then S(•)=G(AG(G(•)))˜H₉
4. if A=0x1259, then S(•)=G(AG(G(•))))˜H₁₀
5. if A=0x1c38, then S(•)=G(AG(G(•)))˜H₁₂
6. if A=0x1c38, then S(•)=G(AG(G(•)))˜H₁₄
7. if A=0x12f7, then S(•)=G(AG(G(•))))˜H₁₅
   where Hᵢ=(Gᵢ+1)% 16, i=3, 6, 9, 10, 12, 14, 15. Hence, we can construct H₉ and H₁₄ by using the G(•), matrices 0x1529, 0x1c38 and the parameters needed for transformation, i.e. Hᵢ=A(S(Bx ⊕ c) ⊕ d), in Table 5.

TABLE 5
The parameters A, B, c, d of H9, H14 of SERPENT

| | A | B | c | d |
|---|---|---|---|---|
| SERPENT H₉ | 0x4896 | 0x62e3 | 0xe | 0xd |
| SERPENT H₁₄ | 0xba4d | 0xb8da | 0xf | 0x1 |

In order to implement 8 s-boxes of protected (or unprotected) SERPENT cipher, it may be desired to construct the core G(•), the function α(•), and parameters which are defined in the Table 4, 5, and 6. By using this construction, the hardware implementation can be reduced significantly because all the s-boxes can share the most expensive part, i.e non-linear operators G(•) and α(•).

TABLE 6
The parameters A, B, c, d and class of some s-boxes

| | A | B | c | d | class |
|---|---|---|---|---|---|
| HB2 S0 [2] | 0x8749 | 0x42ef | 0x7 | 0x9 | 9 |
| HB2 S1 [2] | 0x1e43 | 0xf8c2 | 0xb | 0x9 | 10 |
| HB2 S2 [2] | 0x8d9a | 0x412b | 0xc | 0x7 | 14 |
| HB2 S3 [2] | 0x3f41 | 0x76f2 | 0xe | 0x7 | 15 |
| HB2 S0⁻¹ [2] | 0xfcb5 | 0x75fc | 0xc | 0x1 | 9 |
| HB2 S1⁻¹ [2] | 0x59de | 0x328e | 0xa | 0x2 | 10 |
| HB2 S2⁻¹ [2] | 0xf314 | 0xe6f4 | 0xd | 0xc | 15 |
| HB2 S3⁻¹ [2] | 0xa9d8 | 0x8217 | 0x7 | 0x8 | 14 |
| SERPENT S₃ [1] | 0xfbc5 | 0xbaf6 | 0x9 | 0xe | 9 |
| SERPENT S₄ [1] | 0xa98d | 0x8147 | 0xb | 0x9 | 14 |
| SERPENT S₅ [1] | 0xad89 | 0x124e | 0x0 | 0x8 | 14 |
| SERPENT S₇ [1] | 0x8947 | 0x427f | 0x6 | 0x4 | 9 |
| SERPENT S₃⁻¹ [1] | 0x7498 | 0x24ef | 0xa | 0xb | 9 |
| SERPENT S₄⁻¹ [1] | 0xf431 | 0xbaf2 | 0x6 | 0xd | 15 |
| SERPENT S₅⁻¹ [1] | 0x1f34 | 0xbaf8 | 0xe | 0x6 | 15 |
| SERPENT S₇⁻¹ [1] | 0x5cbf | 0xd5f6 | 0x4 | 0xd | 9 |

Especially, H₁₂˜H₁₄ even if G₁₂ and G₁₄ are not linearly equivalent.

In the following, using the factorization structure according to various embodiments to reduce the number of cores will be described.

Let (x, y, z, w) be the 4-bit input and (X, Y, Z, W) be 4-bit output. Then the ANF of (X, Y, Z, W)=G₉(x, y, z, w):

X=xyz ⊕ zw ⊕ yz ⊕ xy ⊕ x

Y=yzw ⊕ xyz ⊕ zw ⊕ xw ⊕ y

Z=zw ⊕ yw β xw ⊕ z

W=xyz ⊕ yz ⊕ xw ⊕ xz ⊕ xy ⊕ w (3)

According to various embodiments, we found that there exist two 4×4-bit invertible A=0x5a19, B=0x5bcd, and a constant c=0x9 such that the ANF of

(X, Y, Z, W)=A(G₁₄(B(x, y, z, w) ⊕ c))

is as follows:

X=xyz ⊕ zw ⊕ yz ⊕ w ⊕ z ⊕ y ⊕ x ⊕ 1

Y=yzw ⊕ xyz ⊕ zw ⊕ xw ⊕ z

Z=zw ⊕ yw ⊕ xw ⊕ w ⊕ x

W=xyz ⊕ yz ⊕ xw ⊕ xz ⊕ w ⊕ 1 (4)

Denote (X, Y, Z, W)=V(x, y, z, w) a vectorial boolean function of which the ANF is as follows:

X=xy ⊕ w ⊕ z ⊕ y ⊕ 1

Y=z ⊕ y

Z=w ⊕ z

W=xy ⊕ 1 (5)

Then, A(G₁₄(B(x, y, z, w) ⊕ c)) ⊕ V(x, y, z, w)=G₉(x, y, z, w). Instead of implementing two cores G₉ and G₁₄, we can implement only core G₁₄ and A, B, c, V. Hence, the number of cores required for unprotected s-boxes of SERPENT may also be 2 by using the method according to various embodiments.

In the following, a list of parameters of the s-boxes not in A₁₆ will be described.

To factorize a given optimal s-box S(•) which is not in A₁₆, according to various embodiments, the following steps may be taken:

1. Determine the class of the s-box S(•), i.e. finding the A, B, c, d such that S(x)=A(Gᵢ(Bx ⊕ c) ⊕ d).

2. After knowing the class i, then get the corresponding F and G in Table 3, i.e. Gᵢ(•)=α(F(G(•))).

3. Then the given S(x) may be factorized according to various embodiments as follows:

S(x)=A(α(F(G(Bx ⊕ c))) ⊕ d)

In the Table 6, the parameters according to various embodiments, i.e. class, A, B, c, d, of several 4-bit s-boxes not in A₁₆ are provided.

As described above, according to various embodiments, devices and methods to make 3-share TI applicable for any 4-bit optimal s-boxes, may be provided, for example using a Pipeline structure and/or a Factorization structure. According to various embodiments, a deep insight into the decomposition of an optimal s-box is provided.

Based on this insight, it may be possible to quickly find its decomposition (or factorization). As described above, the Pipeline structure and the factorization structure according to various embodiments may be useful for designing the hardware implementation.

In the following devices and methods for 3-share Threshold Implementations, for example for 4-bit S-boxes, will be described.

One of the most promising lightweight hardware countermeasures against SCA attacks is the so-called Threshold Implementation (TI) countermeasure. According to various embodiments, many of the remaining open issues towards its applicability may be resolved. For example, it may be defined which optimal (from a cryptographic point of view) S-boxes can be implemented with a 3-share TI. Furthermore, devices and methods according to various embodiments may be provided to efficiently implement these S-boxes. As an example, the devices and methods according to various embodiments may be applied to PRESENT and the devices and methods according to various embodiments may decrease the area requirements of its protected S-box by 57%.

Side Channel Attacks (SCA) may exploit the fact that while a device is processing data, information about this data is leaked through different channels, e.g., power consumption, electromagnetic emanation and so forth. DPA may be a commonly used technique analyzing many measurements. It may exploit the correlation between intermediate results, which partly depend on a secret, and the power consumption.

Several countermeasures have been provided during the last years, for example, to increase the SNR ratio, to balance the leakage of different values or to break the link between the processed data and the secret, i.e., masking. Due to the presence of glitches masked implementation might still be vulnerable to DPA. A further countermeasure against DPA may be called Threshold Implementation (TI). It is based on secret sharing (or multi-party computation) techniques and is provable secure against first order DPA even in the presence of glitches. Furthermore, it can be implemented very efficiently in hardware.

The number of shares required for a Threshold Implementation may depend on the degree d of the non-linear function (S-box) and it may be shown that it is at least d+1. It may imply that the higher the degree of the non-linear function, the more shares are required and the larger is the implementation. Since a degree of two is the minimal degree of a non-linear function, the optimal number of shares is three. Therefore, to apply a 3-share Threshold Implementation to a larger degree function, this function may be represented as a composition of quadratic functions.

In the following, an example of various embodiments for a 3-share Threshold Implementations of optimal 4-bit S-boxes will be described. These S-boxes may fulfill certain cryptographic properties which make them secure against cryptanalytic attacks. According to various embodiments, the question of which of these optimal S-boxes can be protected using only 3-shares will be answered. According to various embodiments, two methodologies according to various embodiments will be described which allow to efficiently implement these S-boxes in a 3-share TI scenario. Application of these methodologies to the PRESENT S-box resulting in the smallest protected implementation known so far will be described. Furthermore, the security of a design according to devices and methods according to various embodiments will be described by practical measurements. A new attack model will be described and use the sum of square t-differences will be described as a new distinguisher.

In the following, an open conjecture and important definitions, and two new methodologies according to various embodiments that allow to significantly reduce the area requirements of all TI S-boxes using the PRESENT S-box as an example will be described. Furthermore, the optimized hardware implementation of TI-PRESENT and its experimental analysis according to various embodiments will be described.

In the following, decomposability of 4-bit S-boxes will be described. The 3-share Threshold countermeasure can only be applied to permutations with a maximum degree of two. Therefore, the decomposability of cubic 4-bit S-boxes into a composition of several quadratic vectorial boolean functions plays an important role when implementing the 3-share Threshold countermeasure. For example, the cubic PRESENT S-box may be decomposed into two quadratic vectorial boolean function F(•) and G(•) in order to apply the 3-share Threshold countermeasure.

In the following, the Nikova's conjecture will be proved. It is conjectured that any decomposable 4-bit S-box/permutation must belong to A₁₆, i.e., the alternating group of the 4-bit symmetric group S₁₆. A 4-bit S-box/permutation is considered as decomposable if and only if it can be written as a composition of several quadratic vectorial boolean functions. We recall some properties of a permutation in S₁₆.

Lemma 7. A₁₆ is a subgroup of S₁₆, i.e., if p₁(•) and p₂(•) are permutations in A₁₆, then the resulting permutation of their composition p₃(•)=p₁(p₂(•)) must be in A₁₆ as well.

Lemma 8. All linear and quadratic permutations in S₁₆ are in A₁₆.

Proof. There may be around 226 quadratic permutations. Since the number of linear and quadratic permutations is not big, the parity of all these permutations may be checked. If a permutation has a parity of +1, it belongs to A₁₆. All parities of the considered permutations are +1. Hence, all these permutations belong to A₁₆.

Theorem 5. If a permutation p(•) can be written as a composition of quadratic permutations, then p(•) is in A₁₆.

Proof. The theorem is directly derived from the lemma 1 and lemma 2.

Corollary 1. Theorem 1 implies that if a cubic permutation does not belong to A₁₆, it can not be written as a composition of several quadratic permutations.

Note 2. The composition of a quadratic permutation and a linear permutation is again a quadratic permutation. Hence, a quadratic permutation is able to be decomposed in a composition of linear and quadratic permutations. This fact will be used for an improvement of the hardware implementation of the PRESENT S-box according to various embodiments, like will be described in further detail below.

In the following, optimal and decomposable 4-bit S-boxes will be described.

An S-box may be considered as optimal if it fulfills the following requirements:

Definition 6. Let S:F₂⁴→F₂⁴ be an S-box. If S fulfills the following conditions we call S an optimal S-box:

1. S is a bijection,

2. Lin(S)=8,

3. Diff (S)=4.

Optimal S-boxes may be important in designing cryptographic ciphers. 16 classes of linearly equivalent S-boxes may be defined in S₁₆.

Definition 7. Two S-boxes S(x), S′(x) are linearly equivalent if there exist two 4×4-bit invertible matrices A, B and two 4-bit vectors c, d such that

S′(x)=A(S(Bx ⊕ c) ⊕ d), ∀x ∈ {0, . . . , 15}

Based on Note 2, if the representative of a considered class is decomposable, then all S-boxes in this class are decomposable as well, i.e., they belong to A₁₆. Checking the parity of the permutation of all class representatives reveals that exactly 8 classes (50%) are decomposable (see Table 7).

TABLE 7
Decomposability of S-box classes.

| Decomposable | 0 | 1 | 2 | 4 | 5 | 7 | 8 | 13 |
|---|---|---|---|---|---|---|---|---|
| Not decomposable | 3 | 6 | 9 | 10 | 11 | 12 | 14 | 15 |

Note 3. The PRESENT S-box belongs to class 1. It implies that the PRESENT S-box is decomposable.

In the following, it will be described how one S-box may be used for all.

In the following, devices and methods according to various embodiments which may improve the hardware implementation costs of the Threshold countermeasure will be described. To illustrate various embodiments, PRESENT may be used as an example.

FIG. 2 as described above shows how to apply the Threshold countermeasure to a 4-bit S-box: first the S-box 202 may be decomposed into two stages G and F (horizontal) 204, then each stage may be shared (vertical) 206. FIG. 2 also shows that F and G may be implemented using six different 8×4 vectorial Boolean functions f₁, f₂, . . . , g₃. In the following, it will be described how to provide the same functionality with only one 8×4 vectorial Boolean function according to various embodiments, this way significantly reducing the area/memory requirements of the S-box.

In the following, the horizontal level will be described. In order to apply the 3-share Threshold countermeasure to a cubic S-box S(•), according to various embodiments, in a first step the S-box may be decomposed into a composition of two quadratic permutations F(•) and G(•) (for example like shown in FIG. 2).

Lemma 9. Assume a vectorial boolean function S(•)=G(G(•)), where G(•) is a vectorial boolean function. Then the hardware implementation of S(•) may be reduced by reusing the implementation of G(•).

Proof. Experiments have shown that the costs for additional logic, e.g., a multiplexer, is less than implementing G(x) twice. Numbers will be provided further below.

The main problem of Lemma 9 may be how to find a G(x) such that G(G(x)) lies in the desired class, e.g., class 1 for the PRESENT S-box. According to various embodiments, it has been discovered that the only classes reachable by the construction G(G(x)) are 0, 1, 2 and 8. For class 1, according to various embodiments, the following quadratic G(x) has been found such that S′(•)=G(G(•)).

$$\begin{matrix}x & & 0 & 1 & 2 & 3 & 4 & 5 & 6 & 7 & 8 & 9 & A & B & C & D & E & F \\ G ( x ) & & 0 & 4 & 1 & 5 & 2 & F & B & 6 & 8 & C & 9 & D & E & 3 & 7 & A \\ G ( G ( x ) ) & & 0 & 2 & 4 & F & 1 & A & D & B & 8 & E & C & 3 & 7 & 5 & 6 & 9\end{matrix}$$

The ANF of G(x, y, z, w)=(g₃, g₂, g₁, g₀) may be as follows:

g₃=x+yz+yw

g₂=w+xy

g₁=y

g₀=z+yw

Using Definition 7, it may be known that the S-box of PRESENT S(•) is linearly equivalent to the found S′(•)=G(G(•)), i.e

S(x)=A(S′(Bx ⊕ c) ⊕ d)=A(G(G(Bx ⊕ c)) ⊕ d), ∀x ∈ {0, . . . , 15}.

It may be constructed with the following 4×4-bit matrices A, B and 4-bit constants c, d:

$$A = ( \begin{matrix}1 & 0 & 1 & 0 \\ 0 & 1 & 0 & 0 \\ 1 & 0 & 0 & 0 \\ 1 & 0 & 1 & 1\end{matrix} ) , \\ B = ( \begin{matrix}1 & 1 & 0 & 0 \\ 0 & 1 & 1 & 0 \\ 0 & 0 & 1 & 0 \\ 0 & 1 & 0 & 1\end{matrix} )$$

c and d are (0001)2=1 and (0101)2=5, respectively.

In the following, the vertical level will be described. In the second step, G(•) may be divided into three 8×4 vectorial Boolean functions G₁(•), G₂(•) and G₃(•). In practice, all these vectorial boolean functions may be implemented separately. According to various embodiments, the implementation costs may be reduced by using the following lemma:

Lemma 10. The hardware templates of the vectorial boolean functions of G(•) are the same except for the indices of the inputs and the existence of constants.

Proof. The lemma is derived from the construction of the vectorial boolean functions G₁(•), G₂(•) and G₃(•). For example, if we take the latter constructed G(x), then:

G₁(x₂, y₂, z₂, w₂, x₃, y₃, z₃, w₃)=(g₁₃, g₁₂, g₁₁, g₁₀)

g₁₃=x₂+y₂z₂+y₂z₃+y₃z₂+y₂w₂+y₂w₃+y₃w₂

g₁₂=w₂+x₂y₂+x₂y₃+x₃y₂

g₁₁=y₂

g₁₀=z₂+y₂w₂+y₂w₃+y₃w₂

G₂(x₁, y₁, z₁, w₁, x₃, y₃, z₃, w₃)=(g₂₃, g₂₂, g₂₁, g₂₀)

g₂₃=x₃+y₃z₃+y₁z₃+y₃z₁+y₃w₃+y₁w₃+y₃w₁

g₂₂=w₃+x₃y₃+x₁y₃+x₃y₁

g₂₁=y₃

g₂₀=z₃+y₃w₃+y₁w₃+y₃w₁

G₃(x₁, y₁, z₁, w₁, x₂, y₂, z₂, w₂)=(g₃₃, g₃₂, g₃₁, g₃₀)

g₃₃=x₁+y₁z₁+y₁z₂+y₂z₁+y₁w₁+y₁w₂+y₂w₁

g₃₂=w₁+x₁y₁+x₁y₂+x₂y₁

g₃₁=y₁

g₃₀=z₁+y₁w₁+y₁w₂+y₂w₁

Therefore, only G₁(•) needs to be implemented and then it may be reused for G₂(•) and G₃(•) by arranging the inputs appropriately.

It is to be noted that this technique may be applied not only for this special case but also in general whenever a function is shared. For example, let's take a look at the following example, stating the following ANFs for G₁, G₂ and G₃:

G₁(x₂, y₂, z₂, w₂, x₃, y₃, z₃, w₃)=(g₁₃, g₁₂, g₁₁, g₁₀)

g₁₃=y₂+z₂+w₂

g₁₂=1+y₂+z₂

g₁₁=1+x₂+z₂+y₂w₂+y₂w₃+y₃w₂+z₂w₂+z₂w₃+z₃w₂

g₁₀=1+w₂+x₂y₂+x₂y₃+x₃y₂+x₂z₂+x₂z₃+x₃z₂+y₂z₂+y₂z₃+y₃z₂

G₂(x₁, y₁, z₁, w₁, x₃, y₃, z₃, w₃)=(g₂₃, g₂₂, g₂₁, g₂₀)

g₂₃=y₃+z₃+w₃

g₂₂=y₃+z₃

g₂₁=x₃+z₃+y₃w₃+y₁w₃+y₃w₁+z₃w₃+z₁w₃+z₃w₁

g₂₀=w₃+x₃y₃+x₁y₃+x₃y₁+x₃z₃+x₁z₃+x₃z₁+y₃z₃+y₁z₃+y₃z₁

G₃(x₁, y₁, z₁, w₁, x₂, y₂, z₂, w₂)=(g₃₃, g₃₂, g₃₁, g₃₀)

g₃₃=y₁+z₁+w₁

g₃₂=y₁+z₁

g₃₁=x₁+z₁+y₁w₁+y₁w₂+y₂w₁+z₁w₁+z₁w₂+z₂w₁

g₃₀=w₁+x₁y₁+x₁y₂+x₂y₁+x₁z₁+x₁z₂+x₂z₁+y₁z₁+y₁z₂+y₂z₁

It can be seen that the method according to various embodiments may also be applied to this implementation by handling the constants separately as gᵢ₀; gᵢ₁; gᵢ₂; gᵢ₃ include similar monomials with different indices. Alternatively, it is possible to use correction terms, i.e., add the constant 1 to g₂₂; g₂₁; g₂₀ and g₃₂; g₃₁; g₃₀ such that the template of the terms match again.

In the following, a hardware implementation according to various embodiments will be described. As described above, in an example, the cubic 4×4 S-boxes using the PRESENT S-box may be decomposed. In the following, an exemplary hardware implementation of PRESENT protected with the TI countermeasure with a shared data path and an unshared Key schedule will be described. The design flow used will be described, and the hardware architectures and implementation results will be described.

For the hardware implementation in VHDL (VHSIC (very-high-speed integrated circuits) Hardware Description Language), a Boolean minimization tool may be used to obtain the four ANFs of G. Functional simulation may be performed, and the designs may be synthesized to the Virtual Silicon standard cell library. The power consumption of the ASIC implementations according to various embodiments have been estimated. For synthesis and for power estimation the compiler was advised to keep the hierarchy and use a clock frequency of 100 KHz. It is to be noted that the wire-load model used, though it is the smallest available for this library, still simulates the typical wire-load of a circuit with a size of around 10,000 GE. These figures are provided for information only and it may not be possible to compare them across different technologies.

In the following, an architecture and design according to various embodiments will be described.

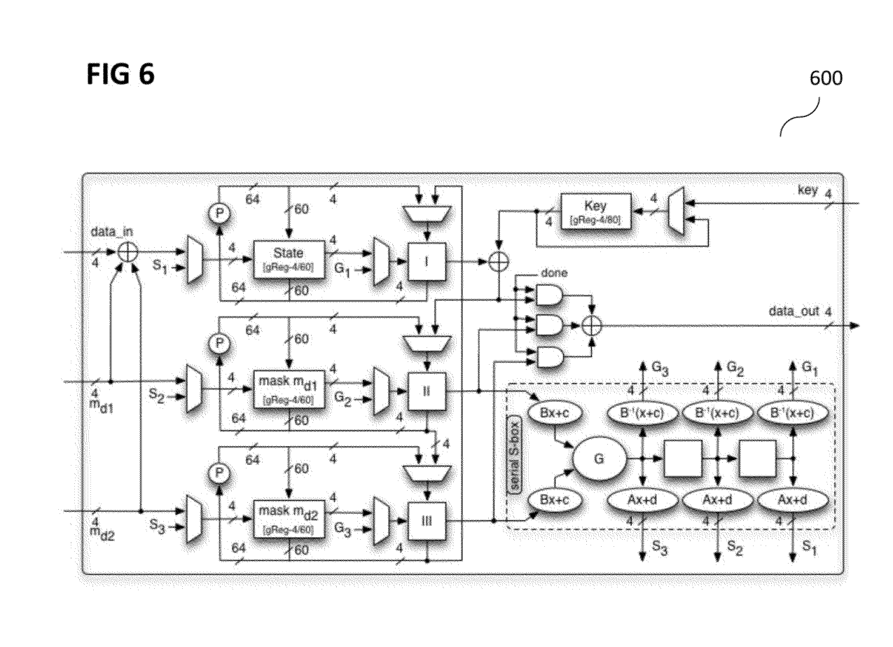

FIG. 6 shows an architecture 600 according to various embodiments, for example an architecture of a serialized TI-PRESENT-80 using our new optimization techniques.

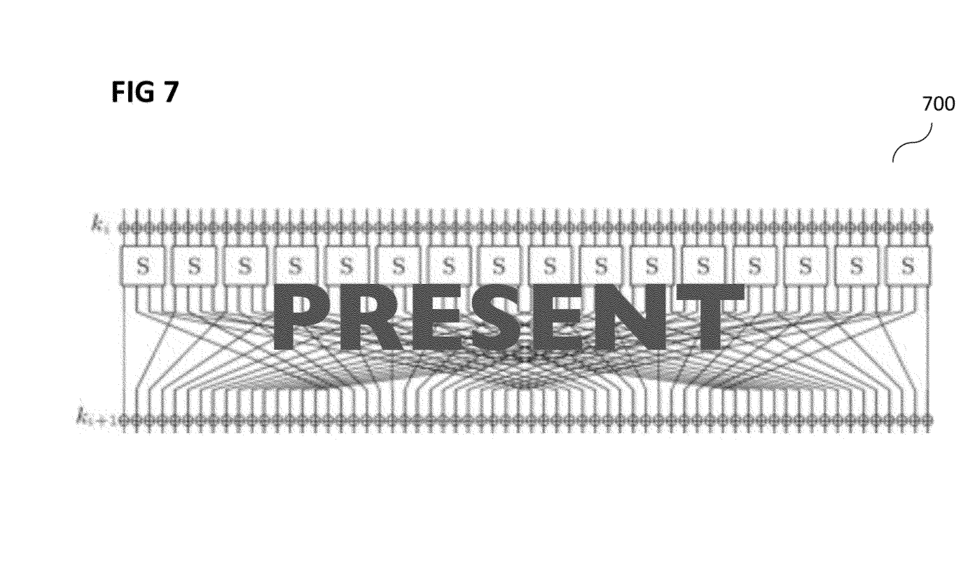

FIG. 7 shows one round of the lightweight block cipher PRESENT. It may be lightweight, for example 3000 GE and 15 uA. In FIG. 7, S may denote an S-box and kᵢ and kᵢ₊₁ may denote the key rounds of round i and i+1.

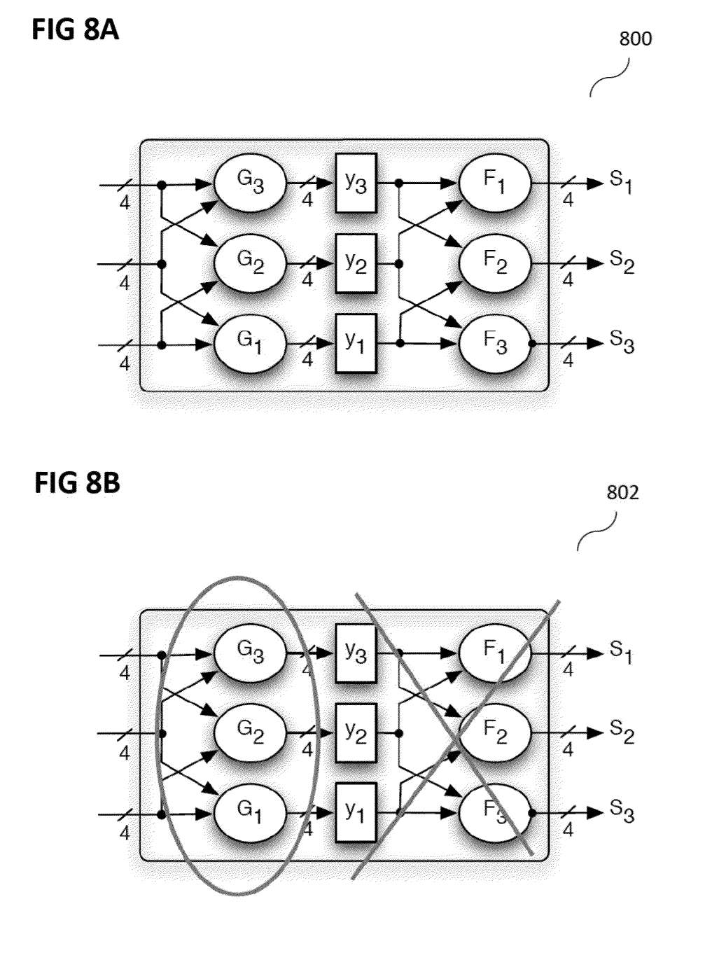

FIG. 8A shows a commonly used architecture 800. It may use 400 GE.

FIG. 8B shows an illustration 802 showing how to modify the architecture using the described methods. It may use about 160 GE. Like illustrated in FIG. 8B, according to various embodiments, the functions F1, F2 and F3 do not need to be implemented.

According to various embodiments, the S-box module and storage modules for the shared data path may be provided. The three shares of the data path are stored in three identical replications of the storage module denoted by State, md1 and md2. Each of them includes 60 flip-ops that may act as a normal 60-bit wide register (vertical shifting direction) or as a 4-bit wide 15 stages shift register (horizontal). The remaining 4-bits may be stored in a similar way (denoted with I, II and III in FIG. 6) but with two additional 2-to-1 input MUXes (one for each shifting direction). Those 4-bits may act as a shift register in a vertical way, allowing to change the input to G. The parallel 60-bit wide output is concatenated with the output of the 4-bit wide register and may be transformed by the P-layer of PRESENT. The Key module may store the key state and may perform the PRESENT keyschedule.

The S-box module may include of only one 8×4 vectorial Boolean function G (47 GE) that is used for all three shares and for both staged instead of six as in commonly used methods (for example as shown in FIG. 2). According to various embodiments, the PRESENT S-box S(x) may be implemented as S(x)=A(G(G(Bx ⊕ c)) ⊕ d). Therefore, the inputs to G may be transformed by Bx+c (two times 7 GE) and its output may be temporarily stored for two clock cycles in two consecutive 4-bit flip-ops (48 GE) until all three shares have been computed.

Since, for the second stage, we do not need to process the input to G by Bx+c, we transform all three shares by B⁻¹(x+c) (21 GE; compared to using two MUXes (19 GE), this approach may have a simpler control logic at roughly the same area requirements) and store them in I, II and III. After the second stage is completed, the three shares may be transformed by Ax+d (18 GE) and stored in the shift registers State, md1 and md2, which are shifting horizontally, and the new 4-bit nibbles may be ready to be processed.

The FSM module may include one initial state, six states for the S-box, one state for the permutation layer that is used instead of the sixth S-box state at the end of each round, a finished state that sets the done signal to high, and a done state. The output is gated by an AND-gate that only lets data pass to the final output XOR after 31 rounds have been processed. It takes in total 6*16=96 clock cycles for one round, hence the output may be ready after 2976 clock cycles. During the 16 clock cycles required to output the result nibble-wise, the next message and key can be loaded, which may take 20 clock cycles. Thus in total the architecture according to various embodiments may require 2996 clock cycles to process one message, compared to 578 clock cycles reported in commonly used architectures.

In the following, performance figures will be given. A goal is to investigate the savings that one can achieve using the optimization technique according to various embodiments.

However, in other approaches, a combination of clock-gating and scan-flip-flops may be used, which results in storing costs of 6 GE per bit (plus a negligible overhead for clock gating logic). For ASIC prototyping it is sometimes not desirable to use clock gating, thus we decided to use D-flip-flops with enable signal, which results in storage costs of 9 GE per bit.

In order to have a fairer comparison with other results, we also describe post-synthesis figures for a modified variant of their source code where we replaced the clock gating and scan-flip-flops with D-flip-flops with enable (9 GE). The upper half of Table 8 shows these post-synthesis results.

TABLE 8
Breakdown comparison of the post-synthesis implementation
results of a serialized PRESENT-80 are shown in the upper half using D-flip-
flops with enable (D-FF + en). The lower half shows estimated figures using
scan-flip-flops and clock gating (s-FF + cg). All figures are Gate Equivalents
(GE).

| | Ref. | Etc. | Key | FSM | State | m_{d1} | m_{d2} | S-box | Sum |
|---|---|---|---|---|---|---|---|---|---|
| D-FF + en | this work | 58 | 778 | 146 | 608 | 608 | 608 | 151 | 2957 |
| | Difference | 0 | 0 | +7 | +21 | +21 | +21 | −200 | −130 |
| s-FF + cg | this work | 58 | 520 | 146 | 410 | 410 | 410 | 151 | 2105 |
| (estimated) | Difference | 0 | 0 | +7 | +21 | +21 | +21 | −200 | −130 |

We have also estimated the area requirements of our implementation using 6 GE scan-flip-flops in combination with clock gating. This is shown in the lower half of Table 8.

It is to be noted that the area of 387 GE for the S-box module in a commonly used method includes of both the shared S-box (359 GE) for the data path and the unshared S-box (28 GE) for the keyschedule. Thanks to a more optimized ANF the unshared PRESENT S-box we used only takes 22 GE, and since the unshared S-box is only used in the KeySchedule module we account its area share there. We have also taken into account that the post-synthesis results of the S-box according to various embodiments, FSM and the top level glue logic (etc.) are smaller than the ones reported for commonly used system and estimated the figures accordingly.

It can be seen that the top level glue logic and the Key module are identical in both architectures, while the control logic (FSM) is slightly more complex for our approach. The architecture according to various embodiments may require six additional 4-bit wide 2-to-1 MUXes, which increase the area requirements of the storage components by 21 GE each. The S-box module is 57% smaller yielding area savings of 200 GE. Using the approach according to various embodiments in total it is possible to save 130 GE.

In the following, experimental results will be described. In order to evaluate the security of our new approach, we analyzed power consumption traces. In the following, the measurement setup is introduced and subsequently the results of different DPA experiments are shown and compared to results of commonly used systems. In addition, additional techniques may be used to investigate possible first order leakage. Furthermore, an attack targeting countermeasures will be described where the masks and the masked state are processed simultaneously as it is usually the case for Threshold implementations.

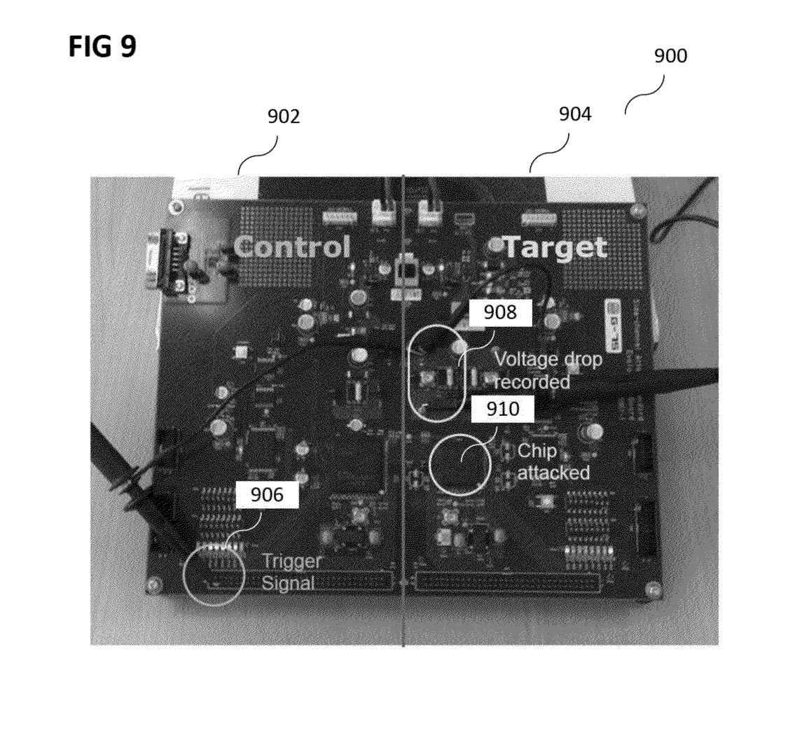

FIG. 9 shows an illustration 900 of the experimental setup according to various embodiments. A control side 902 and a target side 904 are shown. A trigger signal 906 may be provided. Like illustrated in 908, a voltage drop may be recorded. 910 illustrates the attacked chip.

In the following, the measurement setup will be described. A device hosts two FPGAs, i.e., one control FPGA and one cryptographic FPGA which is decoupled from the rest of the board to minimize electronic noise from surrounding components. It is supplied with a voltage of 1V by an external stabilized power supply as well as with a 3 MHz clock (24 MHz on-board clock oscillator utilizing a clock divider of 8). The power consumption is measured over a 1Ω resistor inserted in the VDD line by using a differential probe. All power traces are collected at a sampling rate of 1 GS/s.

In the following, side-channel resistance will be described.

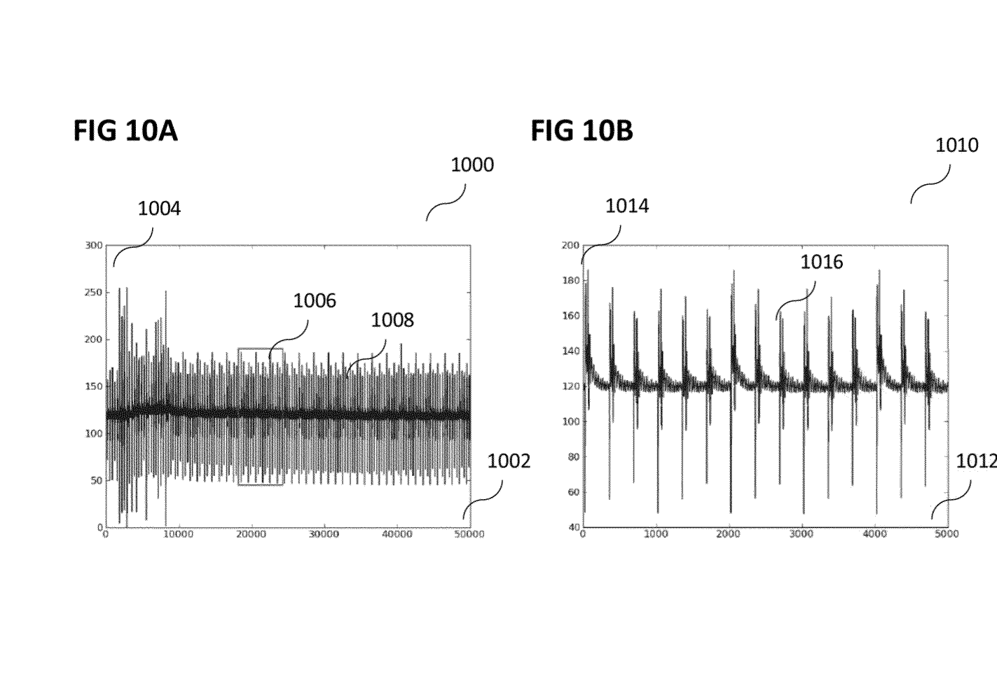

FIG. 10A and FIG. 10B show diagrams 1000, 1010 of an exemplary power trace 1008, 1016 of the first round of an encryption run as well as a zoomed extract 1006, 1010. Horizontal axes 1002 in FIG. 10A and 1012 in FIG. 10B may indicate the sample number. The vertical axes 1004 and 1014 may indicate the normalized power consumption.

The high peaks in the power consumption at the left FIG. 10A may be caused by the loading of the plaintext and key to the cryptographic FPGA. The encryption starts at sample 8500—for our analyses we omit these first 8500 samples. In FIG. 10B, one can clearly identify the peaks in the power consumption for every single clock cycle (300 samples between the peaks equals 3 MHz).

To verify the measurement setup we first used 200,000 measurements and attacked our implementation knowing the random masks, i.e., we can guess intermediate masked values. Plaintexts and masks were chosen at random and are uniformly distributed. Commonly, the Hamming distance of two subsequent state nibbles may be chosen as the leakage model. This model may not be optimal since all 3*64 bit of the three states (State, md1, md2) are updated simultaneously. Hence, when attacking only one nibble, there is a lot of noise decreasing the correlation. We found that attacking the Hamming distance between two subsequent outputs of an S-box stage is more promising since here only 12 bit (3 shares*4-bit S-box output) are updated simultaneously.

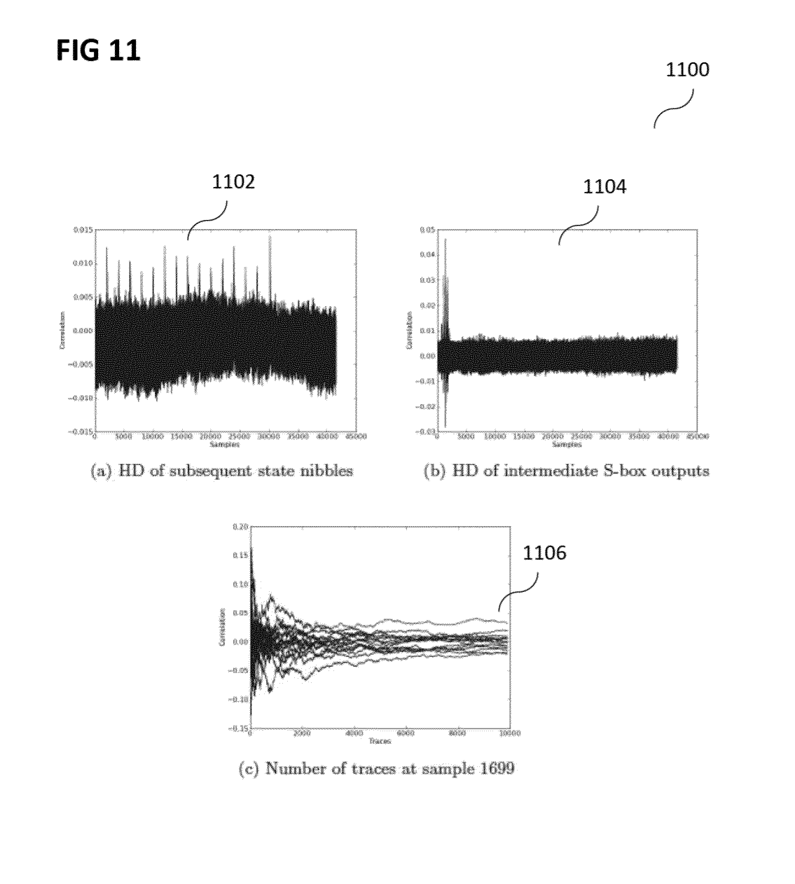

FIG. 11 shows the correlation results using the commonly used model and the model according to various embodiments. FIG. 11a) shows a diagram 1102 of Hamming distance of subsequent state nibbles. FIG. 11b) shows a diagram 1104 of Hamming distance of intermediate S-box outputs. FIG. 11c) shows a diagram 1106 of number of traces at sample 1699. FIG. 11 shows the DPA results with known masks. Using the commonly used model one can nicely determine the 15 peaks representing the 15 updates of the state, i.e., the 15 shift operations, but the correlation coefficient may be approximately five times lower than the one attacking the intermediate values between two S-box stages. The correct key guess becomes distinguishable after approximately 4,000 measurements.

Next, we measured 5,000,000 traces. We considered three different attack models for the DPA attack: HW (Hamming weight) of the S-box input, HW of the S-box output and the HD (Hamming distance) between two subsequent states. In addition we also considered the model attacking the intermediate value between S-box stages according to various embodiments. All attacks were performed nibble-wise, i.e., 16 key guesses had to be analyzed.

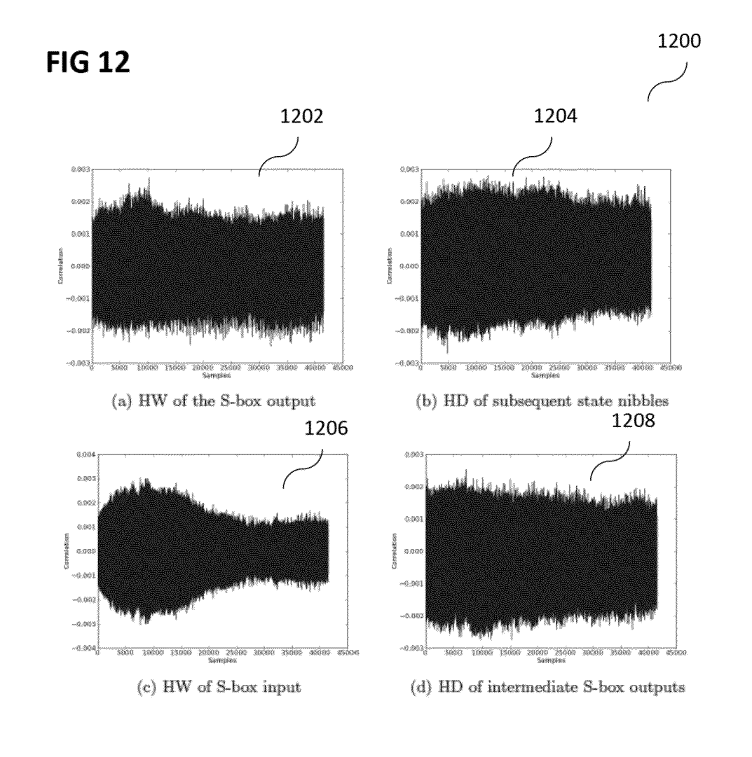

FIG. 12 shows the results 1200 of the DPA attack for the four models. As can be seen—and as expected—none of the attack models reveals the correct key nibble. FIG. 12a) shows a diagram 1202 illustrating Hamming weight of the S-box output. FIG. 12b) shows a diagram 1204 illustrating HD of subsequent state nibbles. FIG. 12c) shows a diagram 1206 illustrating HW of S-box input. FIG. 12d) shows a diagram 1208 illustrating a HD of intermediate S-box outputs.

As described above, the DPA analysis may be extended by utilizing additional measures to detect first-order leakage. We try to utilize the sum of square t-differences (SOST). Originally it was used to find points which contain the most information according to the chosen model in a template attack pro ling phase. Here, we use it to see if there are any points containing any information (with a known key). The main advantage of SOST is that it does not require a linear dependency between the attack model and the power consumption contrary to, e.g., the Pearson correlation coefficient.

Subsequently, we tried SOST as a new DPA distinguisher. As classification function we chose the HD of two subsequent state nibbles.

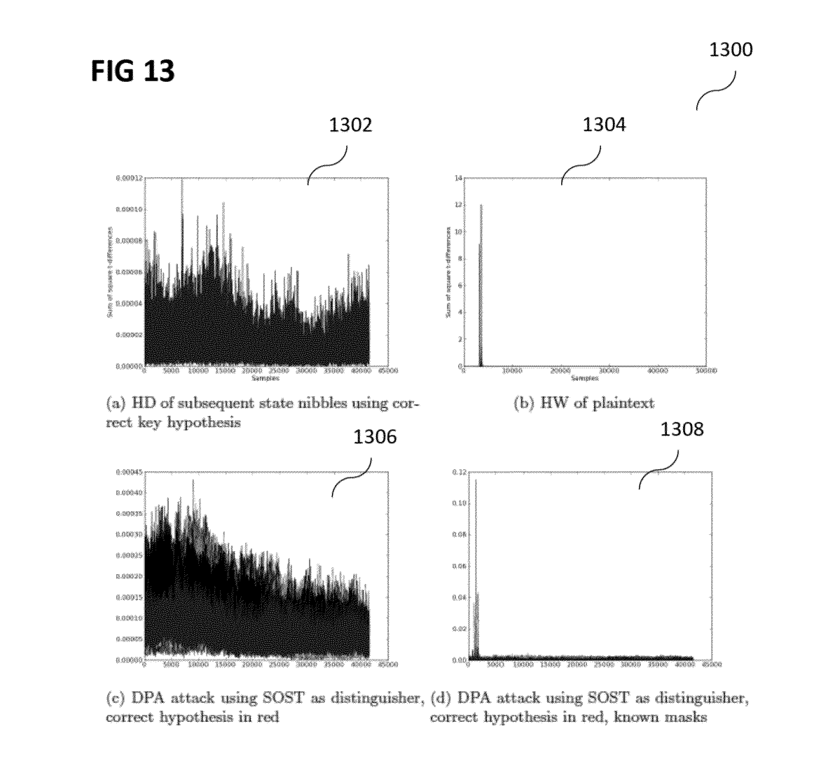

FIG. 13 shows results 1300 using the sum of square t-differences.

As can be seen in FIG. 13a) 1302 the overall information content is very low. For comparison, FIG. 13b) 1304 shows the SOST trace, i.e., the information content targeting a plaintext nibble (note that for this analysis we included the first 8500 samples). Nonetheless, we performed a DPA attack using SOST as a distinguisher. FIG. 13c) 1306 shows the results but as can be seen, there are no clear peaks indicating the correct key guess. To show that the idea indeed works and to highlight the strength of SOST as distinguisher we attacked the intermediate state with known masks using 200,000 measurements as in FIG. 11. FIG. 13d) 1308 shows the result of this attack and as can be seen, the correct key hypothesis can be clearly identified and the relative difference between the highest and the second highest peak is much bigger than using the Pearson correlation coefficient. Hence, it may be worth to evaluate the strength of SOST in more detail.

A Zero-off set attack for the (unlikely) case that masked plaintexts and masks are processed at the same time may be investigated. For commonly used implementations, the implementation according to various embodiments, and especially Threshold Implementations in general, this case may be true and hence these implementations should be susceptible to this attack. Therefore, we took the previously measured 5,000,000 traces and performed the Zero-off set attack.

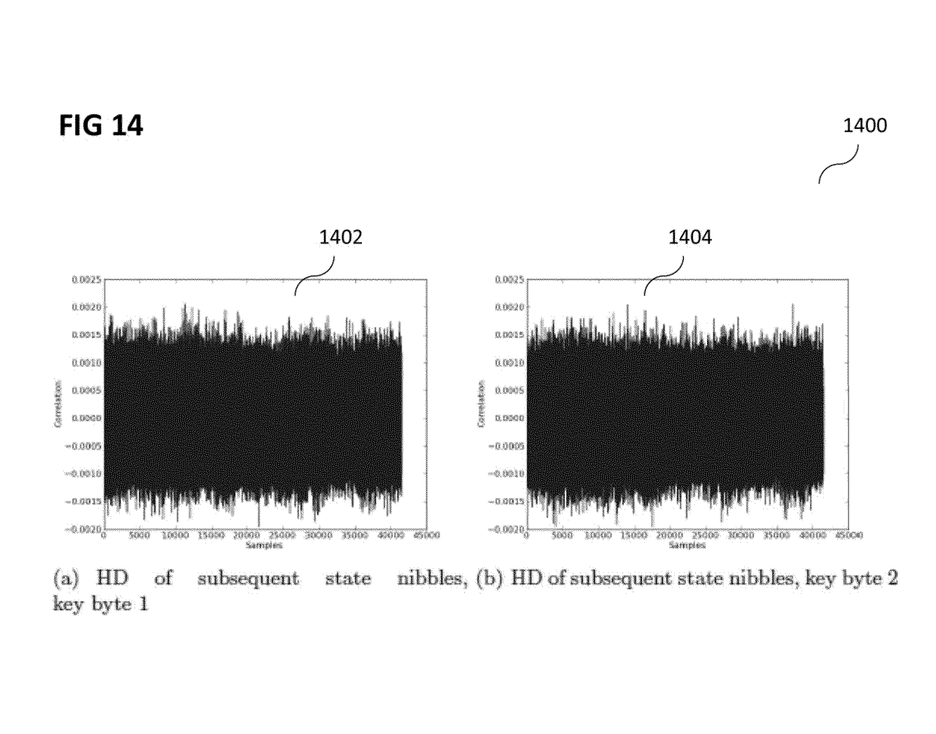

FIG. 14 shows DPA results 1400 of the Zero-off set attack. FIG. 14 shows the results of this attack using the before mentioned Hamming distance model. FIG. 14a) shows a diagram 1402 illustrating a HD of subsequent state nibbles, with key byte 1. FIG. 14b) shows a diagram 1404 illustrating a HD of subsequent state nibbles with by byte 2. As can be seen in FIG. 14 there are some correlation peaks representing the correct key hypothesis rise above the rest. But repeating the attack for the second and third key nibble showed that the correct hypothesis cannot be distinguished. We repeated the attack using different models, i.e., targeting the intermediate state and using the Hamming weight, but none of the attacks worked. Simulations finally showed that the Zero-off set attack, i.e., squaring the power consumption, does not work with Threshold implementations. According to various embodiments, more suitable preprocessing functions may be provided.

As described above, all optimal S-boxes which may be protected by the 3-share Threshold countermeasure belong to A₁₆. According to various embodiments, two methodologies may be provided to efficiently implement these S-boxes in a TI scenario. Applying these methodologies to the PRESENT S-box may allow to reduce its area requirement by 57% (130 GE), resulting in the smallest implementation of a protected PRESENT so far (2105 GE). Furthermore, as described above, the security of the devices and methods according to various embodiments may be proven by practical experiments.

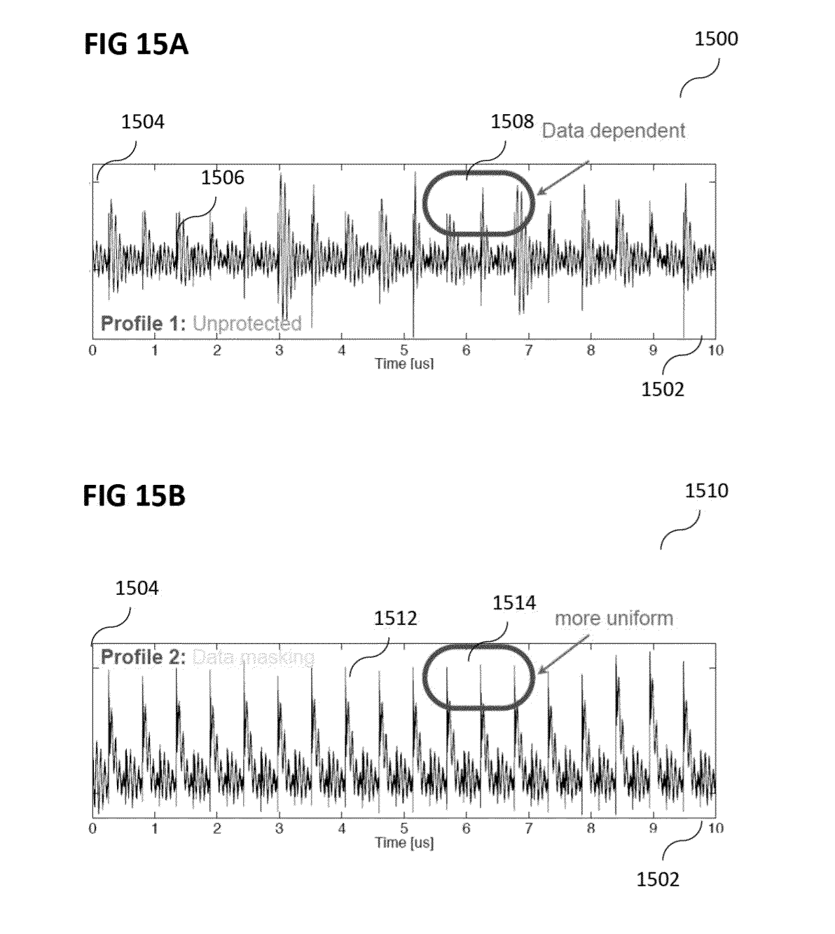

FIG. 15A and FIG. 15B show power traces. The horizontal axes 1502 represent the time. The vertical axes 1504 represent the power consumption. In FIG. 15A, a diagram 1500 is shown illustrating operation of a unprotected device. In FIG. 15B, a diagram 1510 is shown illustrating operation of a device using data masking. As is indicated by 1508, the trajectory of the unprotected device 1506 may be data dependent, while as indicated by 1514, the trajectory 1512 of the device using data masking may be more uniform.

It will be understood that the device and methods according to various embodiments allow reducing the memory requirements of software implementation of S-boxes protected by the TI countermeasure by a factor of six.

The S-box decomposition method and the S-box construction method according to various embodiments may have commercial applications in constrained-environment cryptography, such as RFID (radio frequency identification). Indeed, such devices may only spend a very limited amount of memory dedicated to security and cryptography. Therefore, any method that allows saving some hardware area (and thus the power consumption) may be crucial and may be highly sought after by the industry. The methods and devices according to various embodiments improve the hardware area for many symmetric key cryptography primitives.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1.-24. (canceled)

25. A method for determining a result of applying a first Boolean function to an input, the method comprising:
determining a second Boolean function;
determining a plurality of linear functions;
applying one linear function of the plurality linear functions and the second Boolean function to a value based on the input to determine a first intermediate value; and
applying a further linear function of the plurality of linear functions and the second Boolean function to a value based on the intermediate value to determine the result;
wherein the first Boolean function is of a pre-determined first degree;
wherein the second Boolean function is of a pre-determined second degree; and
wherein the second degree is lower than the first degree.

26. The method of claim 25,
wherein the first Boolean function is a first vectorial Boolean function; and
wherein the second Boolean function is a second vectorial Boolean function.

27. The method of claim 25, further comprising:
applying the one linear function to the input to determine a second intermediate value; and
applying the second Boolean function to the second intermediate value to determine the first intermediate value.

28. The method of claim 25, further comprising:
iteratively applying the second Boolean function to determine the result.

29. The method of claim 25, further comprising:
iteratively performing to determine the result: applying one of the plurality of linear functions and then applying the second Boolean function.

30. A evaluation device comprising:
a determination circuit configured to determine a second Boolean function and a plurality of linear functions; and
an application circuit configured to apply one linear function of the plurality linear functions and the second Boolean function to a value based on an input to determine a first intermediate value;
wherein the application circuit is further configured to apply a further linear function of the plurality of linear functions and the second Boolean function to a value based on the intermediate value to determine a result of applying a first function to the input;
wherein the first Boolean function is of a pre-determined first degree;
wherein the second Boolean function is of a pre-determined second degree; and
wherein the second degree is lower than the first degree.

31. The evaluation device of claim 30,
wherein the first Boolean function is a first vectorial Boolean function; and
wherein the second Boolean function is a second vectorial Boolean function.

32. The evaluation device of claim 30,
wherein the determination circuit is further configured to determine a linear function;
wherein the application circuit is further configured to apply a linear function to the input to determine a second intermediate value; and
wherein the application circuit is further configured to apply the second Boolean function to the second intermediate value to determine the first intermediate value.

33. The evaluation device of claim 30,
wherein the application circuit is further configured to iteratively apply the second Boolean function to determine the result.

34. The evaluation device of claim 30,
wherein the application circuit is further configured to iteratively perform to determine the result:
applying one of the plurality of linear functions and then applying the second function.

35. A method for determining a result of applying a first Boolean function to an input, the method comprising:
determining a plurality of further Boolean functions;
applying a first further Boolean function of the plurality of further Boolean functions to the input to determine a first intermediate value;
applying a second further Boolean function of the plurality of further Boolean functions to the first intermediate value to determine a second intermediate value;
applying a third further Boolean function of the plurality of further Boolean functions to the input to determine a third intermediate value;
applying a fourth further Boolean function of the plurality of further Boolean functions to the third intermediate value to determine a fourth intermediate value; and
determining the result based on the second intermediate value and the fourth intermediate value;
wherein the first Boolean function is of a pre-determined first degree; and
wherein a degree of each of the second Boolean functions is lower than the first degree.

36. The method of claim 35,
wherein the first Boolean function is a first vectorial Boolean function; and
wherein the plurality of further Boolean functions is a plurality of further vectorial Boolean functions.

37. The method of claim 35,
wherein the result is determined based on a bitwise XOR operation of the second intermediate value and the fourth intermediate value.

38. The method of claim 35, further comprising:
determining at least three intermediate values, wherein each intermediate value of the at least three intermediate values is determined based on applying one of the plurality of further Boolean functions to the input, and then applying a further one of the plurality of further Boolean functions; and
determining the result based on the at least three intermediate values.

39. The method of claim 38,
wherein the result is determined based on a bitwise XOR operation of the at least three intermediate values.
